(19) United States
(12) Patent Application Publication
(10) Pub. No.: US 2021/0275874 A1
(43) Pub. Date: Sep. 9, 2021

(54) GOLF BALL AND METHOD OF MAKING SAME

(71) Applicant: Acushnet Company, Fairhaven, MA (US)

(72) Inventor: Jason J. Hinton, Mansfield, MA (US)

(73) Assignee: Acushnet Company, Fairhaven, MA (US)

(21) Appl. No.: 16/811,093

(22) Filed: Mar. 6, 2020

(51) Int. Cl. A63B 37/00; C08L 23/08

(52) U.S. Cl. CPC A63B 37/0039; A63B 37/0048; C08L 2207/04; C08L 2205/03; C08L 23/0892

(57) ABSTRACT

Golf ball incorporating at least one layer comprised of at least one polyethylene-based vitrimer, which may comprise a blend of polyethylene and dioxaborolane maleimide, and in some embodiments, be blended with thermoplastics such as ionomers and/or polyurethanes.

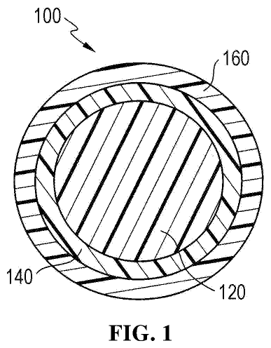

### FIELD OF THE INVENTION

Golf balls incorporating materials that are resilient yet easily processible in conventional golf ball molding operations.

### BACKGROUND OF THE INVENTION

Both professional and amateur golfers use multi-piece, solid golf balls today. Basically, a two-piece solid golf ball includes a solid inner core protected by an outer cover. The inner core is made of a natural or synthetic rubber such as polybutadiene, styrene butadiene, or polyisoprene. The cover surrounds the inner core and may be made of a variety of materials including ethylene acid copolymer ionomers, polyamides, polyesters, polyurethanes, and polyureas.

Three-piece, four-piece, and even five-piece balls have become more popular over the years. Golfers are playing with multi-piece balls for several reasons, including availability of lower-cost materials and the development of new manufacturing technologies which make it possible and cost-effective to produce a multi-layered golf ball having unique desirable resulting performance characteristics. In multi-layered golf balls, each of the core, intermediate layer and cover can be single or multi-layered, and properties such as hardness, modulus, compression, resilience, core diameter, intermediate layer thickness and cover thickness can be preselected and coordinated to target play characteristics such as spin, initial velocity and feel of the resulting golf ball.

Meanwhile, different layer materials can also be pre-selected in these golf ball constructions to impart specific properties and playing features to the ball. In this regard, thermoset materials possess desired mechanical strength and high thermal and chemical resistance, due at least in part to the high cross-link density which results from bonds that form and become irreversibly set once the composition is cured. Unfortunately, thermosets are not melt-processible, and therefore generally cannot be injection molded as an outer layer about a subassembly. And while thermoplastic materials are melt-processible, they don't have or display the same degree of mechanical strength nor the thermal and chemical resistance that thermosets can.

Therefore, a continued need exists for golf balls incorporating materials that can covalently cross-link like thermosetting materials yet flow and are moldable about a subassembly like thermoplastics. Golf balls including compositions allying the advantages of both thermoset and thermoplastic materials and which are meanwhile producible cost effectively within already existing golf ball manufacturing systems without sacrificing important golf ball properties and performance characteristics including for example resilience (CoR), durability, spin, and “feel”, would be particularly useful and desirable. The golf balls of the invention and methods of making same address and fulfill these needs.

### SUMMARY OF THE INVENTION

Advantageously, a golf ball of the invention comprises at least one layer comprised of at least one polyethylene-based vitrimer, which desirably covalently cross-links like a thermoset material, yet flows easily like a thermoplastic composition and can therefore be molded as an outer layer about the subassembly. Meanwhile, important golf ball properties and performance characteristics such as resilience (CoR), durability, spin, and “feel” are not sacrificed. In a particular embodiment, the polyethylene-based vitrimer comprises a blend of polyethylene and dioxaborolane maleimide.

In one embodiment, the blend has a crosslink density of from about 0.2 to about 0.8. In another embodiment, the blend has a crosslink density of greater than 0.8.

In a specific embodiment, the at least one layer consists of the blend.

In one embodiment, the at least one layer comprises a thermoplastic blend of the at least one polyethylene-based vitrimer and at least one ionomer or at least one thermoplastic polyurethane. In one such embodiment, the at least one polyethylene-based vitrimer and ionomer may be blended in a weight percent ratio of from about 2:98 to about 50:50.

In another such embodiment, the at least one polyethylene-based vitrimer and thermoplastic polyurethane mat be blended in a weight percent ratio of from about 2:98 to about 50:50.

In a different embodiment, the at least one polyethylene-based vitrimer may be blended with at least one ionomer and at least one thermoplastic polyurethane. In one particular such embodiment, the at least one polyethylene-based vitrimer, the at least one ionomer and the at least one thermoplastic polyurethane may be blended in a weight percent ratio of from about 2:49:49 to about 50:25:25.

In another such embodiment, the at least one polyethylene-based vitrimer may be blended with the at least one ionomer and the at least one thermoplastic polyurethane in an amount of 2-50 parts polyethylene-based vitrimer per 100 parts of ionomer and polyurethane combined.

In yet another such embodiment, the at least one ionomer may be included in an amount of at least 50 parts ionomer per 100 parts of ionomer and polyurethane combined. In a different embodiment, the at least one thermoplastic polyurethane may be included in an amount of at least 50 parts thermoplastic polyurethane per 100 parts of ionomer and polyurethane combined. In one embodiment, the ionomer and thermoplastic polyurethane may be combined in a weight percent ratio of from about 80:20 to about 20:80.

In a particular embodiment, the at least one layer may comprise a thermoplastic blend of the at least one polyethylene-based vitrimer and at least one ionomer and/or at least one thermoplastic polyurethane; wherein the thermoplastic blend has a material hardness of from about 20 Shore D to about 70 Shore D.

In a specific embodiment, the at least one layer may consist of the thermoplastic blend. In one embodiment, the at least one layer may be an intermediate layer. In one such embodiment, the intermediate layer surrounds a single core. In another such embodiment, the intermediate layer surrounds a subassembly comprised of an inner core and an outer core layer. In a different embodiment, the at least one layer comprises an outer cover layer that may be disposed about a subassembly.

In a specific embodiment, the at least one polyethylene-based vitrimer has a melt flow index of from about 1 g/10 min@190° C./10 kg to about 5 g/10 min@ 190° C./10 kg. Meanwhile, in another specific embodiment, the thermoplastic blend has a melt flow index of from about 1 g/10 min@190° C./2.16 kg to about 5 g/10 min@190° C./2.16 kg.

In one embodiment, the polyethylene-based vitrimer may have a freezing transition temperature Tv of at least about 140° C. and less than 200° C. In another embodiment, the polyethylene-based vitrimer may have a freezing transition temperature Tv of at least about 100° C. and less than 190° C. In yet another embodiment, the polyethylene-based vitrimer has a freezing transition temperature Tv of from about 140° C. to about 185° C.

In a particular embodiment, the polyethylene-based vitrimer may have a relaxation time of from about 3 seconds to about 15 minutes.

The at least one polyethylene-based vitrimer may be blended with at least one millable polyurethane rubber.

Meanwhile, a method of making a golf ball of the invention comprises: providing a subassembly; and forming at least one layer about the subassembly comprised of at least one polyethylene-based vitrimer.

### DETAILED DESCRIPTION OF THE INVENTION

Advantageously, a golf ball of the invention incorporates at least one layer of polyethylene-based vitrimer material having a polymer backbone(s) that may be covalently cross-linked like a thermoset yet flows like a thermoplastic when heated sufficiently. Meanwhile, the polyethylene-based vitrimer material can be processed/molded about a golf ball subassembly cost effectively within already existing golf ball manufacturing systems without sacrificing important golf ball properties and performance characteristics such as resilience (CoR), durability, spin, and “feel”.

In a particular embodiment, the polyethylene-based vitrimer may comprise a blend of polyethylene and dioxaborolane maleimide.

Traditionally, golf ball layers with good processability include materials with few crosslinks via grafted groups like those in Fusabond® or temporary crosslinks such as those comprised by ionic clusters in Surlyn® ionomers. Uniquely, the polyethylene-based vitrimer of the at least one layer has covalent crosslinks in the polyethylene backbone at high crosslink density and yet may be melt processed in a way that is similar to how Surlyn® is processed within conventional golf ball manufacturing systems. Furthermore, in some embodiments, the vitrimers (as the term was coined by Ludwik Leibler at ESPCI in France) can create additional linkages with more common materials used in golf ball layers such as Fusabond® (maleic anhydride grafted).

Polyethylene-based vitrimers are polymer networks which are covalently crosslinked and insoluble yet flow when heated sufficiently and therefore can beneficially impart to the golf ball the desired properties offered by each of thermoset and thermoplastic materials. Conventionally, “thermoset” refers to an irreversible, solid material that crosslinks or cures via interaction with as crosslinking or curing agent and cannot be melted and re-molded after it is cured. Crosslinking may be induced by energy, such as heat, through a chemical reaction (by reaction with a curing agent), or by irradiation. The resulting composition remains rigid when set and does not soften with heating; the long-chain polymer molecules cross-link with each other to give a rigid structure.

In contrast, the term “thermoplastic” refers to a material that can be melted and re-molded—is capable of softening or melting when heated and of hardening again when cooled. Thermoplastic polymer chains often are not cross-linked or are lightly crosslinked using a chain extender, but the term “thermoplastic” as used herein may refer to materials that initially act as thermoplastics, such as during an initial extrusion process or injection molding process, but which also may be crosslinked, such as during a compression molding step to form a final structure.

Polyethylene-based vitrimers incorporating dioxaborolane maleimide macroscopically phase separate into regions that are dioxaborolane maleimide-concentrated and unconcentrated, resulting in relatively low insoluble fractions and overall crystallinity. Meanwhile, such polyethylene-based vitrimers micro-phase separate into hierarchial nanostructures of aggragating dioxaborolane maleimide. In vitrimer systems, crosslink functional groups and network strands have different polarizabilities.

Polyethylene, a semi-crystalline polyolefin, can be converted into a vitrimer by grafting dioxaborolane maleimide onto the polyethylene backbone, followed by crosslinking via addition of bis-dioxaborolane. Polyethylene-based vitrimers undergo complex self-assembly in both the molten and semi-crystalline state. At micron-length scales, polyethylene-based vitrimers macro-phase separate to form a graft-rich percolating network and graft-poor domains. At the nanoscale, enthalpic incompatibility between the polyethylene backbone and grafts induces hierarchical micro-phase separation.

Vitrimers consist of covalent organic networks having permanent connectivity at all temperatures yet become malleable (flow) when heated sufficiently. The vitrimer may be heated to a temperature that is above both the vitrimer's traditional glass transition temperature Tg (transition to a rubbery state) as well as above its unique freezing transition temperature Tv. The vitrimer's freezing transition temperature, Tᵥ is defined as the temperature above which a reversible network topology can be achieved through bond exchange—that is, the temperature at which an exchange reaction rate increases and the vitrimer flows, and therefore, the temperature below which the network arrangement can freeze upon cooling. In more quantitative terms, Tᵥ is the temperature at which η=10¹² Pa·s, the traditionally defined solid to liquid transition viscosity.

In particular embodiments, Tv may be within a range of from about 140° C. to less than 200° C., or greater than 140° C., or about 150° C. or greater, or about 160° C. or greater, or about 170° C. or greater, or about 180° C. or greater, or between about 140° C. and 200° C., of between about 150° C. and 200° C., or between about 160° C. and 200° C., or between about 170° C. and 200° C., or between about 180° C. and 200° C.

However, embodiments are indeed envisioned wherein Tv may be below about 140° C. and/or above 200° C.

Meanwhile, the “relaxation time” is the time period or duration that the polyethylene-based vitrimer can flow at or above Tv. Examples of suitable relaxation times range from less than 10 seconds to up to about 15 minutes, or longer.

In this regard, both Tv and relaxation time may be at least partially controlled or otherwise impacted by adjusting polyethylene-based vitrimer cross-link density, intrinsic rigidity of monomers, density of exchangeable bonds and groups, and by using facilitating additives.

As used herein, “crosslink density” refers to moles of crosslinked basic units per weight unit of the cross-linked polymer. In one embodiment, the blend of polyethylene and dioxaborolane maleimide may have a crosslink density of from about 0.2 to about 0.8. In another embodiment, the blend has a crosslink density of greater than 0.8.

In one embodiment, the cross-link density of the blend is about 0.05 or greater, or from about 0.05 to about 1.0. In another embodiment, the cross-link density of the blend is about 0.1 or greater. In still another embodiment, the cross-link density of the blend is about 0.2 or greater. In yet another embodiment, the cross-link density of the blend is from about 0.35 to about 0.85. In still another embodiment the cross-link density of the blend is about 0.5 or greater. Alternatively, the cross-link density of the polyethylene-based vitrimer compositions of the invention may be about 0.8 or greater.

One skilled in the art will understand that the presence and degree of crosslinking, i.e., the crosslink density, can be determined by a variety of methods, such as dynamic mechanical thermal analysis (DMTA) in accordance with ASTM E1640-99.

The polyethylene-based vitrimer composition formulation may include one or more “facilitating agents” which may i) participate in the structure of the cross-links (thereby impacting physical properties such as glass transition temperature, etc.); or ii) serve to help crosslink the c=c bond in the bis-dioxaborolane but would not change the structure of the crosslink. It is also envisioned that some facilitating agents may dually participate in the structure of the cross-links as well as serve to help crosslink the c=c bond in the bis-dioxaborolane.

In one embodiment, at least one non-metallocene (Ziegler-Natta) facilitating agent may be used to synthesize the at least one polyethylene-based vitrimer. For example, the non-metallocene catalyst complex may be based on a metal such as, for example, neodymium, nickel, cobalt, or titanium, and combinations thereof. Other non-metallocene based catalysts may include, but are not limited to, catalysts based on gadolinium, iron, lanthanum, praseodymium, samarium, titanium, vandadium, zirconium, and combintations thereof. Aluminum and boron co-catalysts also can also be used. In other embodiments, an alkyllithium (for example, butyllithium) or “anionic” facilitating agent may be used. In many embodiments, non-metallocene (Ziegler-Natta) facilitating agents can be used in amounts similar to amounts known and used in the golf ball art in connection with producing/curing rubber materials.

In other embodiments, metallocene-based facilitating agents create polymers in which the order and orientation of the monomers in the polymer and the amount and type of branching in each polymer chain is essentially the same. Some examples of suitable metallocene-based catalysts include ferrocene, cobaltocene, nickelocene, titanocene dichloride, zirconocene dichloride, vanadiumocene, gadolinocene, and samraocene-based catalysts, and combinations thereof. In many embodiments, metallocene-based facilitating agent can be used in amounts similar to amounts known and used in the golf ball art in connection with producing/curing rubber materials.

Furthermore, facilitating agents may include free-radical initiators selected from organic peroxides, high energy radiation sources capable of generating free-radicals, and combinations thereof. In one preferred version, the polyethylene-based vitrimer is peroxide-cured. Suitable organic peroxides include, but are not limited to, dicumyl peroxide; n-butyl-4,4-di(t-butylperoxy)valerate; 1,1-di(t-butylperoxy)3,3,5-trimethylcyclohexane; 2,5-dimethyl-2,5-di(t-butylperoxy)hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; and combinations thereof. Free-radical initiators are generally present in the polyethylene-based vitrimer composition in an amount of at least 0.05 parts by weight per 100 parts of the total polyethylene-based vitrimer composition, or an amount within the range having a lower limit of 0.05 parts or 0.1 parts or 1 part or 1.25 parts or 1.5 parts or 2.5 parts or 5 parts by weight per 100 parts of the total polyethylene-based vitrimer composition, and an upper limit of 2.5 parts or 3 parts or 5 parts or 6 parts or 10 parts or 15 parts by weight per 100 parts of the total polyethylene-based vitrimer composition. Concentrations are in parts per hundred (phr) unless otherwise indicated. As used herein, the term, “parts per hundred,” also known as “phr” or “pph” is defined as the number of parts by weight of a particular component present in a mixture, relative to 100 parts by weight of the polymer component. Mathematically, this can be expressed as the weight of an ingredient divided by the total weight of the polymer, multiplied by a factor of 100.

Moreover, facilitating agents may include, but are not limited to, metal salts of unsaturated carboxylic acids having from 3 to 8 carbon atoms; unsaturated vinyl compounds and polyfunctional monomers (e.g., trimethylolpropane trimethacrylate); phenylene bismaleimide; and combinations thereof. Particular examples of suitable metal salts include, but are not limited to, one or more metal salts of acrylates, diacrylates, methacrylates, and dimethacrylates, wherein the metal is selected from magnesium, calcium, zinc, aluminum, lithium, and nickel. In a particular embodiment, the co-agent is selected from zinc salts of acrylates, diacrylates, methacrylates, and dimethacrylates. In another particular embodiment, the agent is zinc diacrylate (ZDA). When the co-agent is zinc diacrylate and/or zinc dimethacrylate, the co-agent is typically included in the polyethylene-based vitrimer composition in an amount within the range having a lower limit of 1 or 5 or 10 or 15 or 19 or 20 parts by weight per 100 parts of the total polyethylene-based vitrimer composition, and an upper limit of 24 or 25 or 30 or 35 or 40 or 45 or 50 or 60 parts by weight per 100 parts of the total polyethylene-based vitrimer composition.

Non-limiting examples of suitable facilitating agents are as follows. In one embodiment, the facilitating agents may be any known polymerization initiator that decomposes during a curing cycle. Examples of suitable initiators include peroxides such as dicumyl peroxide, n-butyl-4,4-di(t-butylperoxy)-valerate, 1,1-bis(t-butylperoxy)-3,3,5-trimethylcyclohexane, .alpha.,.alpha.′-bis(t-butylperoxy)-diisopropylbenzene, 2,5-dimethyl-2,5-di(t-butylperoxy)hexane, di-t-butyl peroxide, di-t-amyl peroxide, di(2-t-butyl-peroxyisopropyl)benzene peroxide, lauryl peroxide, benzoyl peroxide, t-butyl hydroperoxide, and mixtures thereof. For example, the peroxide initiator may be dicumyl peroxide having an activity between about 40% and about 100%.

In another embodiment, neodymium, nickel, cobalt, titanium, aluminum, boron, and alkylithium based facilitating agents may be included in the polyethylene-based vitrimer composition/formulation. Alternatively, ferrocene, cobaltocene, nickelocene, titanocene dichloride, zirconocene dichloride, vanadiumocene, gadolinocene, and samraocene based facilitating additives may be included in the polyethylene-based vitrimer composition/formulation.

In yet other embodiments, the facilitating agents can be metal salts of diacrylates, dimethacrylates, and monomethacrylates wherein the metal is zinc, magnesium, calcium, barium, tin, aluminum, lithium, sodium, potassium, iron, zirconium, and/or bismuth. In a specific embodiment, zinc diacrylate (ZDA)”), zinc dimethacrylate (“ZDMA”), or mixtures thereof is preferred. ZDA provides golf balls with a high initial velocity. The ZDA can be of various grades of purity. For the purposes of this invention, the lower the quantity of zinc stearate present in the ZDA the higher the ZDA purity. ZDA containing less than about 20% zinc stearate is preferable. More preferable is ZDA containing about 4-8% zinc stearate. Suitable commercially available zinc diacrylates include those from Sartomer Co. The ZDA amount can be varied to suit the desired compression, spin and feel of the resulting golf ball.

In still other embodiments, the facilitating agent can be a mono-(meth)acrylic acid or di-(meth)acrylic acid metal salt, wherein the cation is zinc, magnesium, cadmium, or mixtures thereof. As used herein, the term “(meth)acrylic” includes both methacrylic and acrylic. The facilitating additive may be present in an amount from about 0 to about 50 phr by weight of the vitrimer blend.

Furthermore, zinc diacetate, zinc acetylacetonate and/or zinc acetoacetate may be used as facilitating agents.

Additional facilitating agents that may be used alone or in combination with those mentioned above include, but are not limited to, trimethylolpropane trimethacrylate, trimethylolpropane triacrylate, and the like. It is understood by those skilled in the art that in the case where these facilitating agents are liquids at room temperature, it may be advantageous to disperse these compounds on a suitable carrier to promote ease of incorporation in the vitrimer mixture.

Examples of cobalt facilitating agents include without limitation elemental cobalt and cobalt compounds such as Raney® cobalt; cobalt chloride; cobalt bromide; cobalt iodide; cobalt oxide; cobalt sulfate; cobalt carbonate; cobalt phosphate; cobalt phthalate; cobalt carbonyl; cobalt acetylacetonate; cobalt diethyldithiocarbamate; cobalt anilinium nitrite; cobalt dinitrosyl chloride; and mixtures thereof. Particularly, combinations of these cobalt compounds with a dialkyl aluminum monochloride (e.g., diethyl aluminum monochloride and diisobutyl aluminum monochloride), a trialkyl aluminum (e.g., triethyl aluminum, tri-n-propyl aluminum, triisobutyl aluminum, and tri-n-hexyl aluminum), an alkyl aluminum sesquichloride (e.g., ethyl aluminum sesquichloride), or aluminum chloride are preferred.

Nickel facilitating agents include without limitation one-component catalysts such as nickel on diatomaceous earth, two-component catalysts such as Raney® nickel/titanium tetrachloride, and three-component catalysts such as nickel compound/organometal/trifluoroborate etherate. Examples of the nickel compounds used herein include, but are not limited to, reduced nickel on carrier; Raney® nickel; nickel oxides; nickel carboxylate; organic nickel complex salts, and mixtures thereof. Examples of the organometals include, but are not limited to, trialkyl aluminums such as triethyl aluminum, tri-n-propyl aluminum, triisobutyl aluminum, and tri-n-hexyl aluminum; alkyl lithiums such as n-butyl lithium, s-butyl lithium, t-butyl lithium, 1,4-butane dilithium; dialkyl zincs such as diethyl zinc and dibutyl zinc, and mixtures thereof.

Lanthanide series facilitating agents comprising a lanthanide series element and compound, an organoaluminum compound, a Lewis base, and optionally, a Lewis acid may be used. The lanthanide compounds used herein include halides, carboxylates, alcoholates, thioalcoholates, and amides. Preferably the lanthanide element is neodymium (Nd). The Lewis bases serve to convert the lanthanide compounds into complexes, and acetylacetone and ketone alcohols and the like may be used for this purpose. The Nd catalysts may be used as solution in a suitable solvent such as n-hexane, cyclohexane, n-heptane, toluene, xylene, benzene, etc. or carried on suitable carriers such as silica, magnesia, and magnesium chloride. The polymerization temperature typically ranges from about −30° C. to about 150° C., preferably from about 10° C. to about 80° C. The polymerization pressure may vary depending on other conditions.

Other facilitating agents may comprise unsaturated vinyl compounds including without limitation N,N′-m-phenylene dimaleimide (available as Vanax® MBM from R.T. Vanderbilt); trimethylolpropane trimethacrylate (Sartomer® SR-350 from Sartomer); triallyl trimellitate (Triam® 705 from Wako Chemicals); triallylisocyanurate (Talc® from Nippon Kasei Chemical); and mixtures thereof. In addition, poly-functional monomers, phenylene bismaleimide and sulfur may also be used as the facilitating agents.

It is envisioned that in some embodiments, the facilitating agents may be for example tertiary amines and/or tributyl amine and/or triphenyl phosphine and/or dioctyltin catalysts.

In general, transesterification catalysts are suitable facilitating agents.

Herein, the terms “polyethylene-based vitrimer” and “polyethylene-based vitrimer composition” are used herein interchangeably to refer to the resulting polyethylene-based vitrimer material that may be produced using the ingredients and methods as disclosed herein

In a specific embodiment, the at least one layer may consist of the blend.

In one embodiment, the at least one layer may comprise or consist of a thermoplastic blend of the at least one polyethylene-based vitrimer and at least one thermoplastic composition such as at least one ionomer and/or at least one thermoplastic polyurethane. In one such embodiment, the at least one polyethylene-based vitrimer and at least one ionomer may be blended in a weight percent ratio of from about 2:98 to about 50:50. In specific such embodiments, the at least one polyethylene-based vitrimer and at least one ionomer may be blended in a weight percent ratio of (2-15):(98-85), or (5-20):(95-80), or (10-25):(90-75), or (15-30):(85-70), or (20-35):(80-65), or (25-40):(75-60), or (30-45):(70-55), or (35-50):(65-50), or (40-50):(60-50).

In different such embodiment, the at least one polyethylene-based vitrimer and at least one thermoplastic polyurethane may be blended in a weight percent ratio of from about 2:98 to about 50:50. In specific such embodiments, the at least one polyethylene-based vitrimer and at least one thermoplastic polyurethane may be blended in a weight percent ratio of (2-45):(98-55), or (5-40):(95-60), or (10-35):(90-65), or (20-45):(80-55), or (25-35):(75-65), or (30-50):(70-50), or (35-45):(65-55), or (40-50):(60-50).

In yet another embodiment, the at least one polyethylene-based vitrimer may be blended with at least one ionomer and at least one thermoplastic polyurethane. In one particular such embodiment, the at least one polyethylene-based vitrimer, the at least one ionomer and the at least one thermoplastic polyurethane may be blended in a weight percent ratio of from about 2:49:49 to about 50:25:25. In specific such embodiments, the at least one polyethylene-based vitrimer, the at least one ionomer and the at least one thermoplastic polyurethane may blended in a weight percent ratio of from about 10:50:40 to about 45:30:25, or from about 15:55:30 to about 40:40:20, or from about 20:50:30 to about 35:50:15, or from about 30:35:35 to about 40:40:20, or from about 10:40:50 to about 45:25:30, or from about 15:30:55 to about 40:20:40, or from about 20:30:50 to about 35:15:50, or from about 30:35:35 to about 40:20:40.

In another such embodiment, the at least one polyethylene-based vitrimer may be blended with the at least one ionomer and the at least one thermoplastic polyurethane in an amount of 2-50 parts polyethylene-based vitrimer per 100 parts of ionomer and polyurethane combined. In specific such embodiments, the at least one polyethylene-based vitrimer may be blended with the at least one ionomer and the at least one thermoplastic polyurethane in an amount of 2-10 parts polyethylene-based vitrimer per 100 parts of ionomer and polyurethane combined, or in an amount of 5-15 parts polyethylene-based vitrimer per 100 parts of ionomer and polyurethane combined, or in an amount of 10-20 parts polyethylene-based vitrimer per 100 parts of ionomer and polyurethane combined, or in an amount of 15-25 parts polyethylene-based vitrimer per 100 parts of ionomer and polyurethane combined, or in an amount of 20-35 parts polyethylene-based vitrimer per 100 parts of ionomer and polyurethane combined, or in an amount of 25-40 parts polyethylene-based vitrimer per 100 parts of ionomer and polyurethane combined, or in an amount of 30-45 parts polyethylene-based vitrimer per 100 parts of ionomer and polyurethane combined, or in an amount of 35-50 parts polyethylene-based vitrimer per 100 parts of ionomer and polyurethane combined.

Alternatively, the at least one ionomer may be included in this tri-part blend in an amount of at least 50 parts ionomer per 100 parts of ionomer and polyurethane combined, or in an amount of at least 60 parts ionomer per 100 parts of ionomer and polyurethane combined, or in an amount of at least 70 parts ionomer per 100 parts of ionomer and polyurethane combined, or in an amount of at least 80 parts ionomer per 100 parts of ionomer and polyurethane combined, or in an amount of at least 90 parts ionomer per 100 parts of ionomer and polyurethane combined.

In a different embodiment, the at least one thermoplastic polyurethane may be included in this at tri-part blend in an amount of 50 parts thermoplastic polyurethane per 100 parts of ionomer and polyurethane combined, or in an amount of 60 parts thermoplastic polyurethane per 100 parts of ionomer and polyurethane combined, or in an amount of 70 parts thermoplastic polyurethane per 100 parts of ionomer and polyurethane combined, or in an amount of 80 parts thermoplastic polyurethane per 100 parts of ionomer and polyurethane combined, or in an amount of 90 parts thermoplastic polyurethane per 100 parts of ionomer and polyurethane combined.

In one embodiment, the ionomer and thermoplastic polyurethane may be included in this tri-part blend in a weight percent ratio of from about 80:20 to about 20:80, or from about 75:25 to about 25:75, or from about 70:30 to about 30:70, or from about 65:35 to about 35:65, or from about 60:40 to about 40:60, or from about 55:45 to about 45:55.

In a specific embodiment the at least one layer may comprise a thermoplastic blend of the at least one polyethylene-based vitrimer and at least one of the ionomer and/or the at least one thermoplastic polyurethane; wherein the thermoplastic blend has a material hardness of from about 20 Shore D to about 70 Shore D. In these embodiments, the at least one polyethylene-based vitrimer may be blended either or a blend of the at least one ionomer or at least one thermoplastic polyurethane, and in a wt. percent ratio of vitrimer to ionomer, thermoplastic polyurethane, or blend of 2-50:98-50.

In a specific embodiment, the at least one layer may consist of the thermoplastic blend.

It is envisioned that any of the core, intermediate layer, cover and/or coating layer may comprise or consist to the polyethylene-based vitrimer or a blend thereof with a thermoplastic polymer such as an ionomer and/or thermoplastic polyurethane. In one preferred embodiment, the at least one layer may be an intermediate layer. In one such embodiment, the intermediate layer surrounds a single core. In another such embodiment, the intermediate layer surrounds a subassembly comprised of an inner core and an outer core layer. The intermediate layer may have any known thickness and in a specific embodiment be a moisture barrier layer.

In a different embedment, the at least one layer comprises an outer cover layer that is disposed about a subassembly.

In a specific embodiment, the at least one polyethylene-based vitrimer has a melt flow index of from about 1 g/10 min@190° C./10 kg to about 5 g/10 min@ 190° C./10 kg. Meanwhile, in another specific embodiment, the thermoplastic blend has a melt flow index of from about 1 g/10 min@190° C./2.16 kg to about 5 g/10 min@190° C./2.16 kg.

Non-limiting examples of thermoplastic polymers suitable for blending with the polyethylene-based vitrimer include thermoplastic polyurethane(s), thermoplastic urea(s), thermoplastic urea-urethane hybrid(s), or combinations/blends thereof.

Non-limiting examples of suitable thermoplastic polyurethanes include TPUs sold under the tradenames of Texin® 250, Texin® 255, Texin® 260, Texin® 270, Texin®950U, Texin® 970U, Texin®1049, Texin®990DP7-1191, Texin® DP7-1202, Texin®990R, Texin®993, Texin®DP7-1049, Texin® 3203, Texin® 4203, Texin® 4206, Texin® 4210, Texin® 4215, and Texin® 3215, each commercially available from Covestro LLC, Pittsburgh Pa.; Estane® 50 DT3, Estane®58212, Estane®55DT3, Estane®58887, Estane®EZ14-23A, Estane®ETE 50DT3, each commercially available from Lubrizol Company of Cleveland, Ohio; and Elastollan®WY1149, Elastollan®1154D53, Elastollan®1180A, Elastollan®1190A, Elastollan®1195A, Elastollan®1185AW, Elastollan®1175AW, each commercially available from BASF; Desmopan® 453, commercially available from Bayer of Pittsburgh, Pa., and the E-Series TPUs, such as D 60 E 4024 commercially available from Huntsman Polyurethanes of Germany.

In general, polyurethanes contain urethane linkages formed by reacting an isocyanate group (—N═C═O) with a hydroxyl group (OH). The polyurethanes are produced by the reaction of a multi-functional isocyanate (NCO—R—NCO) with a long-chain polyol having terminal hydroxyl groups (OH—OH) in the presence of a catalyst and other additives. The chain length of the polyurethane prepolymer is extended by reacting it with short-chain diols (OH—R′—OH). The resulting polyurethane has elastomeric properties because of its “hard” and “soft” segments, which are covalently bonded together. This phase separation occurs because the mainly non-polar, low melting soft segments are incompatible with the polar, high melting hard segments. The hard segments, which are formed by the reaction of the diisocyanate and low molecular weight chain-extending diol, are relatively stiff and immobile. The soft segments, which are formed by the reaction of the diisocyanate and long chain diol, are relatively flexible and mobile. Because the hard segments are covalently coupled to the soft segments, they inhibit plastic flow of the polymer chains, thus creating elastomeric resiliency.

By the term, “isocyanate compound” as used herein, it is meant any aliphatic or aromatic isocyanate containing two or more isocyanate functional groups. The isocyanate compounds can be monomers or monomeric units, because they can be polymerized to produce polymeric isocyanates containing two or more monomeric isocyanate repeat units. The isocyanate compound may have any suitable backbone chain structure including saturated or unsaturated, and linear, branched, or cyclic. By the term, “polyamine” as used herein, it is meant any aliphatic or aromatic compound containing two or more primary or secondary amine functional groups. The polyamine compound may have any suitable backbone chain structure including saturated or unsaturated, and linear, branched, or cyclic. The term “polyamine” may be used interchangeably with amine-terminated component. By the term, “polyol” as used herein, it is meant any aliphatic or aromatic compound containing two or more hydroxyl functional groups. The term “polyol” may be used interchangeably with hydroxy-terminated component.

Thermoplastic polyurethanes have minimal cross-linking; any bonding in the polymer network is primarily through hydrogen bonding or other physical mechanism. Because of their lower level of cross-linking, thermoplastic polyurethanes are relatively flexible. The cross-linking bonds in thermoplastic polyurethanes can be reversibly broken by increasing temperature such as during molding or extrusion. That is, the thermoplastic material softens when exposed to heat and returns to its original condition when cooled. On the other hand, thermoset polyurethanes become irreversibly set when they are cured. The cross-linking bonds are irreversibly set and are not broken when exposed to heat. Thus, thermoset polyurethanes, which typically have a high level of cross-linking, are relatively rigid.

While thermoplastic polyurethanes are suitable for blending with the polyethylene-based vitrimers in golf balls of the invention, any other layer of the golf ball not containing any polyethylene-based vitrimer may include a thermoset polyurethane as desired.

Aromatic polyurethanes can be prepared in accordance with this invention and these materials are preferably formed by reacting an aromatic diisocyanate with a polyol. Suitable aromatic diisocyanates that may be used in accordance with this invention include, for example, toluene 2,4-diisocyanate (TDI), toluene 2,6-diisocyanate (TDI), 4,4′-methylene diphenyl diisocyanate (MDI), 2,4′-methylene diphenyl diisocyanate (MDI), polymeric methylene diphenyl diisocyanate (PMDI), p-phenylene diisocyanate (PPDI), m-phenylene diisocyanate (PDI), naphthalene 1,5-diisocynate (NDI), naphthalene 2,4-diisocyanate (NDI), p-xylene diisocyanate (XDI), and homopolymers and copolymers and blends thereof. The aromatic isocyanates are able to react with the hydroxyl or amine compounds and form a durable and tough polymer having a high melting point. The resulting polyurethane generally has good mechanical strength and cut/shear-resistance.

Aliphatic polyurethanes also can be prepared in accordance with this invention and these materials are preferably formed by reacting an aliphatic diisocyanate with a polyol. Suitable aliphatic diisocyanates that may be used in accordance with this invention include, for example, isophorone diisocyanate (IPDI), 1,6-hexamethylene diisocyanate (HDI), 4,4′-dicyclohexylmethane diisocyanate (“H₁₂ MDI”), meta-tetramethylxylyene diisocyanate (TMXDI), trans-cyclohexane diisocyanate (CHDI), and homopolymers and copolymers and blends thereof. Particularly suitable multi-functional isocyanates include trimers of HDI or H₁₂ MDI, oligomers, or other derivatives thereof. The resulting polyurethane generally has good light and thermal stability.

Any polyol available to one of ordinary skill in the art is suitable for use according to the invention. Exemplary polyols include, but are not limited to, polyether polyols, hydroxy-terminated polybutadiene (including partially/fully hydrogenated derivatives), polyester polyols, polycaprolactone polyols, and polycarbonate polyols. In one preferred embodiment, the polyol includes polyether polyol. Examples include, but are not limited to, polytetramethylene ether glycol (PTMEG) which is particularly preferred, polyethylene propylene glycol, polyoxypropylene glycol, and mixtures thereof. The hydrocarbon chain can have saturated or unsaturated bonds and substituted or unsubstituted aromatic and cyclic groups.

In another embodiment, polyester polyols are included in the polyurethane material. Suitable polyester polyols include, but are not limited to, polyethylene adipate glycol; polybutylene adipate glycol; polyethylene propylene adipate glycol; o-phthalate-1,6-hexanediol; poly(hexamethylene adipate) glycol; and mixtures thereof. The hydrocarbon chain can have saturated or unsaturated bonds, or substituted or unsubstituted aromatic and cyclic groups. In still another embodiment, polycaprolactone polyols are included in the materials of the invention. Suitable polycaprolactone polyols include, but are not limited to: 1,6-hexanediol-initiated polycaprolactone, diethylene glycol initiated polycaprolactone, trimethylol propane initiated polycaprolactone, neopentyl glycol initiated polycaprolactone, 1,4-butanediol-initiated polycaprolactone, and mixtures thereof. The hydrocarbon chain can have saturated or unsaturated bonds, or substituted or unsubstituted aromatic and cyclic groups. In yet another embodiment, polycarbonate polyols are included in the polyurethane material of the invention. Suitable polycarbonates include, but are not limited to, polyphthalate carbonate and poly(hexamethylene carbonate) glycol. The hydrocarbon chain can have saturated or unsaturated bonds, or substituted or unsubstituted aromatic and cyclic groups. In one embodiment, the molecular weight of the polyol is from about 200 to about 4000.

There are two basic techniques that can be used to make the polyurethanes: a) one-shot technique, and b) prepolymer technique. In the one-shot technique, the diisocyanate, polyol, and hydroxyl-terminated chain-extender (curing agent) are reacted in one step. On the other hand, the prepolymer technique involves a first reaction between the diisocyanate and polyol compounds to produce a polyurethane prepolymer, and a subsequent reaction between the prepolymer and hydroxyl-terminated chain-extender. As a result of the reaction between the isocyanate and polyol compounds, there will be some unreacted NCO groups in the polyurethane prepolymer. The prepolymer should have less than 14% unreacted NCO groups. Preferably, the prepolymer has no greater than 8.5% unreacted NCO groups, more preferably from 2.5% to 8%, and most preferably from 5.0% to 8.0% unreacted NCO groups. As the weight percent of unreacted isocyanate groups increases, the hardness of the composition also generally increases.

Either the one-shot or prepolymer method may be employed to produce the polyurethane compositions of the invention. In one embodiment, the one-shot method is used, wherein the isocyanate compound is added to a reaction vessel and then a curative mixture comprising the polyol and curing agent is added to the reaction vessel. The components are mixed together so that the molar ratio of isocyanate groups to hydroxyl groups is preferably in the range of about 1.00:1.00 to about 1.10:1.00. In a second embodiment, the prepolymer method is used. In general, the prepolymer technique is preferred because it provides better control of the chemical reaction. The prepolymer method provides a more homogeneous mixture resulting in a more consistent polymer composition. The one-shot method results in a mixture that is inhomogeneous (more random) and affords the manufacturer less control over the molecular structure of the resultant composition.

The polyurethane compositions can be formed by chain-extending the polyurethane prepolymer with a single chain-extender or blend of chain-extenders as described further below. As discussed above, the polyurethane prepolymer can be chain-extended by reacting it with a single chain-extender or blend of chain-extenders. In general, the prepolymer can be reacted with hydroxyl-terminated curing agents, amine-terminated curing agents, and mixtures thereof. The curing agents extend the chain length of the prepolymer and build-up its molecular weight. In general, thermoplastic polyurethane compositions are typically formed by reacting the isocyanate blend and polyols at a 1:1 stoichiometric ratio. Thermoset compositions, on the other hand, are cross-linked polymers and are typically produced from the reaction of the isocyanate blend and polyols at normally a 1.05:1 stoichiometric ratio

A catalyst may be employed to promote the reaction between the isocyanate and polyol compounds for producing the prepolymer or between prepolymer and chain-extender during the chain-extending step. Preferably, the catalyst is added to the reactants before producing the prepolymer. Suitable catalysts include, but are not limited to, bismuth catalyst; zinc octoate; stannous octoate; tin catalysts such as bis-butyltin dilaurate, bis-butyltin diacetate, stannous octoate; tin (II) chloride, tin (IV) chloride, bis-butyltin dimethoxide, dimethyl-bis[1-oxonedecyl)oxy]stannane, di-n-octyltin bis-isooctyl mercaptoacetate; amine catalysts such as triethylenediamine, triethylamine, and tributylamine; organic acids such as oleic acid and acetic acid; delayed catalysts; and mixtures thereof. The catalyst is preferably added in an amount sufficient to catalyze the reaction of the components in the reactive mixture. In one embodiment, the catalyst is present in an amount from about 0.001 percent to about 1 percent, and preferably 0.1 to 0.5 percent, by weight of the composition.

The hydroxyl chain-extending (curing) agents are preferably selected from the group consisting of ethylene glycol; diethylene glycol; polyethylene glycol; propylene glycol; 2-methyl-1,3-propanediol; 2-methyl-1,4-butanediol; monoethanolamine; diethanolamine; triethanolamine; monoisopropanolamine; diisopropanolamine; dipropylene glycol; polypropylene glycol; 1,2-butanediol; 1,3-butanediol; 1,4-butanediol; 2,3-butanediol; 2,3-dimethyl-2,3-butanediol; trimethylolpropane; cyclohexyldimethylol; triisopropanolamine; N,N,N′,N′-tetra-(2-hydroxypropyl)-ethylene diamine; diethylene glycol bis-(aminopropyl) ether; 1,5-pentanediol; 1,6-hexanediol; 1,3-bis-(2-hydroxyethoxy) cyclohexane; 1,4-cyclohexyldimethylol; 1,3-bis-[2-(2-hydroxyethoxy) ethoxy]cyclohexane; 2, 2′-(1,4-phenylenedioxy)diethanol, 1,3-bis-{2-[2-(2-hydroxyethoxy) ethoxy]ethoxy}cyclohexane; trimethylolpropane; polytetramethylene ether glycol (PTMEG), preferably having a molecular weight from about 250 to about 3900; and mixtures thereof.

Suitable amine chain-extending (curing) agents that can be used in chain-extending the polyurethane prepolymer include, but are not limited to, unsaturated diamines such as 4,4′-diamino-diphenylmethane (i.e., 4,4′-methylene-dianiline or “MDA”), m-phenylenediamine, p-phenylenediamine, 1,2- or 1,4-bis(sec-butylamino)benzene, 3,5-diethyl-(2,4- or 2,6-) toluenediamine or “DETDA”, 3,5-dimethylthio-(2,4- or 2,6-)toluenediamine, 3,5-diethylthio-(2,4- or 2,6-)toluenediamine, 3,3′-dimethyl-4,4′-diamino-diphenylmethane, 3,3′-diethyl-5,5′-dimethyl4,4′-diamino-diphenylmethane (i.e., 4,4′-methylene-bis(2-ethyl-6-methyl-benezeneamine)), 3,3′-dichloro-4,4′-diamino-diphenylmethane (i.e., 4,4′-methylene-bis(2-chloroaniline) or “MOCA”), 3,3′,5,5′-tetraethyl-4,4′-diamino-diphenylmethane (i.e., 4,4′-methylene-bis(2,6-diethylaniline), 2,2′-dichloro-3,3′,5,5′-tetraethyl-4,4′-diamino-diphenylmethane (i.e., 4,4′-methylene-bis(3-chloro-2,6-diethyleneaniline) or “MCDEA”), 3,3′-diethyl-5,5′-dichloro-4,4′-diamino-diphenylmethane, or “MDEA”), 3,3′-dichloro-2,2′,6,6′-tetraethyl-4,4′-diamino-diphenylmethane, 3,3′-dichloro-4,4′-diamino-diphenylmethane, 4,4′-methylene-bis(2,3-dichloroaniline) (i.e., 2,2′,3,3′-tetrachloro-4,4′-diamino-diphenylmethane or “MDCA”); and mixtures thereof. One particularly suitable amine-terminated chain-extending agent is Ethacure 300™ (dimethylthiotoluenediamine or a mixture of 2,6-diamino-3,5-dimethylthiotoluene and 2,4-diamino-3,5-dimethylthiotoluene.) The amine curing agents used as chain extenders normally have a cyclic structure and a low molecular weight (250 or less).

When the polyurethane prepolymer is reacted with hydroxyl-terminated curing agents during the chain-extending step, as described above, the resulting polyurethane composition contains urethane linkages. On the other hand, when the polyurethane prepolymer is reacted with amine-terminated curing agents during the chain-extending step, any excess isocyanate groups in the prepolymer will react with the amine groups in the curing agent. The resulting polyurethane composition contains urethane and urea linkages and may be referred to as a polyurethane/urea hybrid. The concentration of urethane and urea linkages in the hybrid composition may vary. In general, the hybrid composition may contain a mixture of about 10 to 90% urethane and about 90 to 10% urea linkages.

More particularly, when the polyurethane prepolymer is reacted with hydroxyl-terminated curing agents during the chain-extending step, as described above, the resulting composition is essentially a pure polyurethane composition containing urethane linkages having the following general structure:

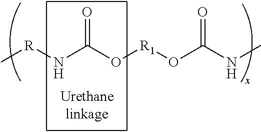

where x is the chain length, i.e., about 1 or greater, and R and R₁ are straight chain or branched hydrocarbon chain having about 1 to about 20 carbons.

However, when the polyurethane prepolymer is reacted with an amine-terminated curing agent during the chain-extending step, any excess isocyanate groups in the prepolymer will react with the amine groups in the curing agent and create urea linkages having the following general structure:

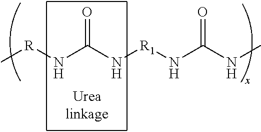

where x is the chain length, i.e., about 1 or greater, and R and R₁ are straight chain or branched hydrocarbon chain having about 1 to about 20 carbons.

The polyurethane compositions may contain other polymer materials including, for example: aliphatic or aromatic polyurethanes, aliphatic or aromatic polyureas, aliphatic or aromatic polyurethane/urea hybrids, olefin-based copolymer ionomer compositions, polyethylene, including, for example, low density polyethylene, linear low density polyethylene, and high density polyethylene; polypropylene; rubber-toughened olefin polymers; acid copolymers, for example, poly(meth)acrylic acid, which do not become part of an ionomeric copolymer; plastomers; flexomers; styrene/butadiene/styrene block copolymers; styrene/ethylene-butylene/styrene block copolymers; dynamically vulcanized elastomers; copolymers of ethylene and vinyl acetates; copolymers of ethylene and methyl acrylates; polyvinyl chloride resins; polyamides, poly(amide-ester) elastomers, and graft copolymers of ionomer and polyamide including, for example, Pebax® thermoplastic polyether block amides, available from Arkema Inc; cross-linked trans-polyisoprene and blends thereof; polyester-based thermoplastic elastomers, such as Hytrel®, available from DuPont; polyurethane-based thermoplastic elastomers, such as Elastollan®, available from BASF; polycarbonate/polyester blends such as Xylex®, available from SABIC Innovative Plastics; maleic anhydride-grafted polymers such as Fusabond®, available from DuPont; and mixtures of the foregoing materials.

In addition, the polyurethane compositions may contain fillers, additives, and other ingredients that do not detract from the properties of the final composition. These additional materials include, but are not limited to, catalysts, wetting agents, coloring agents, optical brighteners, cross-linking agents, whitening agents such as titanium dioxide and zinc oxide, ultraviolet (UV) light absorbers, hindered amine light stabilizers, defoaming agents, processing aids, surfactants, and other conventional additives. Other suitable additives include antioxidants, stabilizers, softening agents, plasticizers, including internal and external plasticizers, impact modifiers, foaming agents, density-adjusting fillers, reinforcing materials, compatibilizers, and the like. Some examples of useful fillers include zinc oxide, zinc sulfate, barium carbonate, barium sulfate, calcium oxide, calcium carbonate, clay, tungsten, tungsten carbide, silica, and mixtures thereof. Rubber regrind (recycled core material) and polymeric, ceramic, metal, and glass microspheres also may be used. Generally, the additives will be present in the composition in an amount between about 1 and about 70 weight percent based on total weight of the composition depending upon the desired properties.

Thermoplastic polyurea compositions are typically formed by reacting the isocyanate blend and polyamines at a 1:1 stoichiometric ratio. The polyurea prepolymer can be chain-extended by reacting it with a single curing agent or blend of curing agents. In general, the prepolymer can be reacted with hydroxyl-terminated curing agents, amine-terminated curing agents, or mixtures thereof. The curing agents extend the chain length of the prepolymer and build-up its molecular weight. Normally, the prepolymer and curing agent are mixed so the isocyanate groups and hydroxyl or amine groups are mixed at a 1.05:1.00 stoichiometric ratio.

A catalyst may be employed to promote the reaction between the isocyanate and polyamine compounds for producing the prepolymer or between prepolymer and curing agent during the chain-extending step. Preferably, the catalyst is added to the reactants before producing the prepolymer. Suitable catalysts include, but are not limited to, those identified above in connection with promoting the reaction between the isocyanate and polyol compounds for producing the prepolymer or between prepolymer and chain-extender during the chain-extending step.

The hydroxyl chain-extending (curing) agents are preferably selected from the same group identified above in connection with polyurethane compositions.

Suitable amine chain-extending (curing) agents that can be used in chain-extending the polyurea prepolymer of this invention include, but are not limited to those identified above in connection with chain-extending the polyurethane prepolymer, as well as 4,4′-bis(sec-butylamino)-diphenylmethane, N,N′-dialkylamino-diphenylmethane, trimethyleneglycol-di(p-aminobenzoate), polyethyleneglycol-di(p-aminobenzoate), polytetramethyleneglycol-di(p-aminobenzoate); saturated diamines such as ethylene diamine, 1,3-propylene diamine, 2-methyl-pentamethylene diamine, hexamethylene diamine, 2,2,4- and 2,4,4-trimethyl-1,6-hexane diamine, imino-bis(propylamine), imido-bis(propylamine), methylimino-bis(propylamine) (i.e., N-(3-aminopropyl)-N-methyl-1,3-propanediamine), 1,4-bis(3-aminopropoxy)butane (i.e., 3,3′-[1,4-butanediylbis-(oxy)bis]-1-propanamine), diethyleneglycol-bis(propylamine) (i.e., diethyleneglycol-di(aminopropyl)ether), 4,7,10-trioxatridecane-1,13-diamine, 1-methyl-2,6-diamino-cyclohexane, 1,4-diamino-cyclohexane, poly(oxyethylene-oxypropylene) diamines, 1,3- or 1,4-bis(methylamino)-cyclohexane, isophorone diamine, 1,2- or 1,4-bis(sec-butylamino)-cyclohexane, N,N′-diisopropyl-isophorone diamine, 4,4′-diamino-dicyclohexylmethane, 3,3′-dimethyl-4,4′-diamino-dicyclohexylmethane, 3,3′-dichloro-4,4′-diamino-dicyclohexylmethane, N,N′-dialkylamino-dicyclohexylmethane, polyoxyethylene diamines, 3,3′-diethyl-5,5′-dimethyl-4,4′-diamino-dicyclohexylmethane, polyoxypropylene diamines, 3,3′-diethyl-5,5′-dichloro-4,4′-diamino-dicyclohexylmethane, polytetramethylene ether diamines, 3,3′,5,5 ‘-tetraethyl-4,4’-diamino-dicyclohexylmethane (i.e., 4,4′-methylene-bis(2,6-diethylaminocyclohexane)), 3,3′-dichloro-4,4′-diamino-dicyclohexylmethane, 2,2′-dichloro-3,3′,5,5′-tetraethyl-4,4′-diamino-dicyclohexylmethane, (ethylene oxide)-capped polyoxypropylene ether diamines, 2,2′,3,3′-tetrachloro-4,4′-diamino-dicyclohexylmethane, 4,4′-bis(sec-butylamino)-dicyclohexylmethane; triamines such as diethylene triamine, dipropylene triamine, (propylene oxide)-based triamines (i.e., polyoxypropylene triamines), N-(2-aminoethyl)-1,3-propylenediamine (i.e., N₃-amine), glycerin-based triamines, (all saturated); tetramines such as N,N′-bis(3-aminopropyl)ethylene diamine (i.e., N₄-amine) (both saturated), triethylene tetramine; and other polyamines such as tetraethylene pentamine (also saturated).

When the polyurea prepolymer is reacted with amine-terminated curing agents during the chain-extending step, as described above, the resulting composition is essentially a pure polyurea composition. On the other hand, when the polyurea prepolymer is reacted with a hydroxyl-terminated curing agent during the chain-extending step, any excess isocyanate groups in the prepolymer will react with the hydroxyl groups in the curing agent and create urethane linkages to form a polyurea-urethane hybrid. Herein, the terms urea and polyurea are used interchangeably.

This chain-extending step, which occurs when the polyurea prepolymer is reacted with hydroxyl curing agents, amine curing agents, or mixtures thereof, builds-up the molecular weight and extends the chain length of the prepolymer. When the polyurea prepolymer is reacted with amine curing agents, a polyurea composition having urea linkages is produced. When the polyurea prepolymer is reacted with hydroxyl curing agents, a polyurea/urethane hybrid composition containing both urea and urethane linkages is produced. The polyurea/urethane hybrid composition is distinct from the pure polyurea composition. The concentration of urea and urethane linkages in the hybrid composition may vary. In general, the hybrid composition may contain a mixture of about 10 to 90% urea and about 90 to 10% urethane linkages. The resulting polyurea or polyurea/urethane hybrid composition has elastomeric properties based on phase separation of the soft and hard segments. The soft segments, which are formed from the polyamine reactants, are generally flexible and mobile, while the hard segments, which are formed from the isocyanates and chain extenders, are generally stiff and immobile.

Moreover, ionomers (e.g. Surlyn®, HNPs, etc.) and blends thereof are likewise suitable for blending with the polyethylene-based vitrimer. Non-limiting examples of ionomers include partially-neutralized ionomers and highly-neutralized ionomers (HNPs), including ionomers formed from blends of two or more partially-neutralized ionomers, blends of two or more highly-neutralized ionomers, and blends of one or more partially-neutralized ionomers with one or more highly-neutralized ionomers.

Ionomers, typically are ethylene/acrylic acid copolymers or ethylene/acrylic acid/acrylate terpolymers in which some or all of the acid groups are neutralized with metal cations such as na, li, mg, and/or zn. Non-limiting examples of commercially available ionomers suitable for use with the present invention include for example SURLYNs® from DuPont and Ioteks® from Exxon. SURLYN® 8940 (Na), SURLYN® 9650 (Zn), and SURLYN® 9910 (Zn) are examples of low acid ionomer resins with the acid groups that have been neutralized to a certain degree with a cation. More examples of suitable low acid ionomers, e.g., Escor® 4000/7030 and Escor® 900/8000, are disclosed in U.S. Pat. Nos. 4,911,451 and 4,884,814, the disclosures of which are incorporated by reference herein. High acid ionomer resins include SURLYN(® 8140 (Na) and SURLYN® 8546 (Li), which have an methacrylic acid content of about 19 percent. The acid groups of these high acid ionomer resins that have been neutralized to a certain degree with the designated cation. Other suitable ionomers for use in the blends of the present invention include polyolefins, polyesters, polystyrenes, SBS, SEBS, and polyurethanes, in the form of homopolymers, copolymers, or block copolymer ionomers.

Ionomers may encompass those polymers obtained by copolymerization of an acidic or basic monomer, such as alkyl (meth)acrylate, with at least one other comonomer, such as an olefin, styrene or vinyl acetate, followed by at least partial neutralization. Alternatively, acidic or basic groups may be incorporated into a polymer to form an ionomer by reacting the polymer, such as polystyrene or a polystyrene copolymer including a block copolymer of polystyrene, with a functionality reagent, such as a carboxylic acid or sulfonic acid, followed by at least partial neutralization. Suitable neutralizing sources include cations for negatively charged acidic groups and anions for positively charged basic groups.

For example, ionomers may be obtained by providing a cross metallic bond to polymers of mono-olefin with at least one member selected from the group consisting of unsaturated mono- or di-carboxylic acids having 3 to 12 carbon atoms and esters thereof (the polymer contains about 1 percent to about 50 percent by weight of the unsaturated mono- or di-carboxylic acid and/or ester thereof). In one embodiment, the ionomer is an E/X/Y copolymers where E is ethylene, X is a softening comonomer, such as acrylate or methacrylate, present in 0 percent to about 50 percent by weight of the polymer (preferably 0 weight percent to about 25 weight percent, most preferably 0 weight percent to about 20 weight percent), and Y is acrylic or methacrylic acid present in about 5 to about 35 weight percent of the polymer, wherein the acid moiety is neutralized about 1 percent to about 100 percent (preferably at least about 40 percent, most preferably at least about 60 percent) to form an ionomer by a cation such as lithium, sodium, potassium, magnesium, calcium, barium, lead, tin, zinc, or aluminum, or a combination of such cations.

Any of the acid-containing ethylene copolymers discussed above may be used to form an ionomer according to the present invention. In addition, the ionomer may be a low acid or high acid ionomer. As detailed above, a high acid ionomer may be a copolymer of an olefin, e.g., ethylene, and at least 16 weight percent of an α,β-ethylenically unsaturated carboxylic acid, e.g., acrylic or methacrylic acid, wherein about 10 percent to about 100 percent of the carboxylic acid groups are neutralized with a metal ion. In contrast, a low acid ionomer contains about 15 weight percent of the α,β-ethylenically unsaturated carboxylic acid.

The ionomers may also be blended with highly neutralized polymers (HNP). As used herein, a highly neutralized polymer has greater than about 70 percent of the acid groups neutralized. In one embodiment, about 80 percent or greater of the acid groups are neutralized. In another embodiment, about 90 percent or greater of the acid groups are neutralized. In still another embodiment, the HNP is a fully neutralized polymers, i.e., all of the acid groups (100 percent) in the polymer composition are neutralized.

Suitable HNPs include, but are not limited to, polymers containing α,β-unsaturated carboxylic acid groups, or the salts thereof, that have been highly neutralized by organic fatty acids. Such HNPs are commercially available from DuPont under the trade name HPF, e.g., HPF 1000 and HPF 2000. The HNP can also be formed using an oxa-containing compound as a reactive processing aid to avoid processing problems, as disclosed in U.S. Patent Publication No. 2003/0225197. In particular, an HNP can include a thermoplastic resin component having an acid or ionic group, i.e., an acid polymer or partially neutralized polymer, combined with an oxa acid, an oxa salt, an oxa ester, or combination thereof and an inorganic metal compound or organic amine compound. As used herein, a partially neutralized polymer should be understood to mean polymers with about 10 to about 70 percent of the acid groups neutralized. For example, the HNP can includes about 10 percent to about 30 percent by weight of at least one oxa acid, about 70 percent to about 90 percent by weight of at least one thermoplastic resin component, and about 2 percent to about 6 percent by weight of an inorganic metal compound, organic amine, or a combination thereof.

In addition, the HNP can be formed from an acid copolymer that is neutralized by one or more amine-based or an ammonium-based components, or mixtures thereof, as disclosed in co-pending U.S. patent application Ser. No. 10/875,725, filed Jun. 25, 2004, entitled “Golf Ball Compositions Neutralized with Ammonium-Based and Amine-Based Compounds,” which is incorporated in its entirety by reference herein.

Furthermore, those of ordinary skill in the art will appreciate that the HNPs may be neutralized using one or more of the above methods. For example, an acid copolymer that is partially or highly neutralized in a manner described above may be subjected to additional neutralization using more traditional processes, e.g., neutralization with salts of organic fatty acids and/or a suitable cation source.

In a particular embodiment, the ionomer may be selected from DuPont® HPF ESX 367, HPF 1000, HPF 2000, HPF AD1035, HPF AD1035 Soft, HPF AD1040, and AD1172 ionomers, commercially available from E. I. du Pont de Nemours and Company. The coefficient of restitution (“COR”), compression, and surface hardness of each of these materials, as measured on 1.55″ injection molded spheres aged two weeks at 23° C./50% RH, are given in Table 1 below.

TABLE 1

| | Solid | Solid Sphere | Solid Sphere Shore D |
|---|---|---|---|
| Example | Sphere COR | Compression | Surface Hardness |
| HPF 1000 | 0.830 | 115 | 54 |
| HPF 2000 | 0.860 | 90 | 47 |
| HPF AD1035 | 0.820 | 63 | 42 |
| HPF AD1035 Soft | 0.780 | 33 | 35 |
| HPF AD 1040 | 0.855 | 135 | 60 |
| HPF AD1172 | 0.800 | 32 | 37 |

In one embodiment, the at least one layer of polyethylene-based vitrimer may comprise an intermediate layer, which may be disposed between a single or multi-layered core and one or more cover layers. The intermediate layer may have any known thickness such as ranging from 0.0003 inches (e.g., being moisture barrier layers in particular) to −0.450 inches, and is sometimes also referred to as a casing or inner cover layer.

Suitable ionomer compositions include partially-neutralized ionomers and highly-neutralized ionomers (HNPs), including ionomers formed from blends of two or more partially-neutralized ionomers, blends of two or more highly-neutralized ionomers, and blends of one or more partially-neutralized ionomers with one or more highly-neutralized ionomers. Preferred ionomers are salts of O/X- and O/X/Y-type acid copolymers, wherein O is an α-olefin, X is a C₃-C₈ α,β-ethylenically unsaturated carboxylic acid, and Y is a softening monomer. O is preferably selected from ethylene and propylene. X is preferably selected from methacrylic acid, acrylic acid, ethacrylic acid, crotonic acid, and itaconic acid. Methacrylic acid and acrylic acid are particularly preferred. Y is preferably selected from (meth) acrylate and alkyl (meth) acrylates wherein the alkyl groups have from 1 to 8 carbon atoms, including, but not limited to, n-butyl (meth) acrylate, isobutyl (meth) acrylate, methyl (meth) acrylate, and ethyl (meth) acrylate.

Preferred O/X and O/X/Y-type copolymers include, without limitation, ethylene acid copolymers, such as ethylene/(meth)acrylic acid, ethylene/(meth)acrylic acid/maleic anhydride, ethylene/(meth)acrylic acid/maleic acid mono-ester, ethylene/maleic acid, ethylene/maleic acid mono-ester, ethylene/(meth)acrylic acid/n-butyl (meth)acrylate, ethylene/(meth)acrylic acid/isobutyl (meth)acrylate, ethylene/(meth)acrylic acid/methyl (meth)acrylate, ethylene/(meth)acrylic acid/ethyl (meth)acrylate terpolymers, and the like. The term, “copolymer,” as used herein, includes polymers having two types of monomers, those having three types of monomers, and those having more than three types of monomers. Preferred α, β-ethylenically unsaturated mono- or dicarboxylic acids are (meth) acrylic acid, ethacrylic acid, maleic acid, crotonic acid, fumaric acid, itaconic acid. (Meth) acrylic acid is most preferred. As used herein, “(meth) acrylic acid” means methacrylic acid and/or acrylic acid. Likewise, “(meth) acrylate” means methacrylate and/or acrylate.

In a particularly preferred version, highly neutralized E/X- and E/X/Y-type acid copolymers, wherein E is ethylene, X is a C₃-C₈ α,β-ethylenically unsaturated carboxylic acid, and Y is a softening monomer are used. X is preferably selected from methacrylic acid, acrylic acid, ethacrylic acid, crotonic acid, and itaconic acid. Methacrylic acid and acrylic acid are particularly preferred. Y is preferably an acrylate selected from alkyl acrylates and aryl acrylates and preferably selected from (meth) acrylate and alkyl (meth) acrylates wherein the alkyl groups have from 1 to 8 carbon atoms, including, but not limited to, n-butyl (meth) acrylate, isobutyl (meth) acrylate, methyl (meth) acrylate, and ethyl (meth) acrylate. Preferred E/X/Y-type copolymers are those wherein X is (meth) acrylic acid and/or Y is selected from (meth) acrylate, n-butyl (meth) acrylate, isobutyl (meth) acrylate, methyl (meth) acrylate, and ethyl (meth) acrylate. More preferred E/X/Y-type copolymers are ethylene/(meth) acrylic acid/n-butyl acrylate, ethylene/(meth) acrylic acid/methyl acrylate, and ethylene/(meth) acrylic acid/ethyl acrylate.

The amount of ethylene in the acid copolymer is typically at least 15 wt. %, preferably at least 25 wt. %, more preferably least 40 wt. %, and even more preferably at least 60 wt. %, based on total weight of the copolymer. The amount of C₃ to C₈ α, β-ethylenically unsaturated mono- or dicarboxylic acid in the acid copolymer is typically from 1 wt. % to 35 wt. %, preferably from 5 wt. % to 30 wt. %, more preferably from 5 wt. % to 25 wt. %, and even more preferably from 10 wt. % to 20 wt. %, based on total weight of the copolymer. The amount of optional softening comonomer in the acid copolymer is typically from 0 wt. % to 50 wt. %, preferably from 5 wt. % to 40 wt. %, more preferably from 10 wt. % to 35 wt. %, and even more preferably from 20 wt. % to 30 wt. %, based on total weight of the copolymer. “Low acid” and “high acid” ionomeric polymers, as well as blends of such ionomers, may be used. In general, low acid ionomers are considered to be those containing 16 wt. % or less of acid moieties, whereas high acid ionomers are considered to be those containing greater than 16 wt. % of acid moieties.

The various O/X, E/X, O/X/Y, and E/X/Y-type copolymers are at least partially neutralized with a cation source, optionally in the presence of a high molecular weight organic acid, such as those disclosed in U.S. Pat. No. 6,756,436, the entire disclosure of which is hereby incorporated herein by reference. The acid copolymer can be reacted with the optional high molecular weight organic acid and the cation source simultaneously, or prior to the addition of the cation source. Suitable cation sources include, but are not limited to, metal ion sources, such as compounds of alkali metals, alkaline earth metals, transition metals, and rare earth elements; ammonium salts and monoamine salts; and combinations thereof. Preferred cation sources are compounds of magnesium, sodium, potassium, cesium, calcium, barium, manganese, copper, zinc, lead, tin, aluminum, nickel, chromium, lithium, and rare earth metals.

Other suitable thermoplastic polymers that may be used to blend with the polyethylene-based vitrimer include but are not limited to, the following polymers (including homopolymers, copolymers, and derivatives thereof: (a) polyester, particularly those modified with a compatibilizing group such as sulfonate or phosphonate, including modified poly(ethylene terephthalate), modified poly(butylene terephthalate), modified poly(propylene terephthalate), modified poly(trimethylene terephthalate), modified poly(ethylene naphthenate), and those disclosed in U.S. Pat. Nos. 6,353,050, 6,274,298, and 6,001,930, the entire disclosures of which are hereby incorporated herein by reference, and blends of two or more thereof; (b) polyamides, polyamide-ethers, and polyamide-esters, and those disclosed in U.S. Pat. Nos. 6,187,864, 6,001,930, and 5,981,654, the entire disclosures of which are hereby incorporated herein by reference, and blends of two or more thereof; (c) polyurethanes, polyureas, polyurethane-polyurea hybrids, and blends of two or more thereof; (d) fluoropolymers, such as those disclosed in U.S. Pat. Nos. 5,691,066, 6,747,110 and 7,009,002, the entire disclosures of which are hereby incorporated herein by reference, and blends of two or more thereof; (e) polystyrenes, such as poly(styrene-co-maleic anhydride), acrylonitrile-butadiene-styrene, poly(styrene sulfonate), polyethylene styrene, and blends of two or more thereof; (f) polyvinyl chlorides and grafted polyvinyl chlorides, and blends of two or more thereof; (g) polycarbonates, blends of polycarbonate/acrylonitrile-butadiene-styrene, blends of polycarbonate/polyurethane, blends of polycarbonate/polyester, and blends of two or more thereof; (h) polyethers, such as polyarylene ethers, polyphenylene oxides, block copolymers of alkenyl aromatics with vinyl aromatics and polyamicesters, and blends of two or more thereof; (i) polyimides, polyetherketones, polyamideimides, and blends of two or more thereof; and (j) polycarbonate/polyester copolymers and blends.

Embodiments ae also envisioned wherein at least one polyethylene-based vitrimer is blended with at least one millable polyurethane rubber such as Millathane® 97; Millathane®26; Millathane®CM; and/or Millathane®E-34, each available from TSE Industries, Inc. It is envisioned that layers a golf ball of the invention may be incorporated via any of retractable pin injection-molding (RPIM), reaction injection-molding (RIM), liquid injection-molding, compression molding, casting, thermoforming or any other method known to one of ordinary skill in the golf ball art for molding outer flowable layers about a subassembly. In this regard, the polyethylene-based vitrimer may be incorporated into a master batch which is then added to thermoplastic polymer(s) prior to molding. Alternatively, the polyethylene-based vitrimer and thermoplastic polymer(s) may be combined by at least one of high shear mixing, followed by molding. Embodiments are also envisioned wherein the layer of inventive polyethylene-based vitrimer or thermoplastic blends including same is formed about a subassembly by spraying, powder-coating, vacuum-forming, flow-coating, dipping, and/or spin-coating.

Retractable pin injection-molding (RPIM) methods generally involve using upper and lower mold cavities that are mated together. The upper and lower mold cavities form a spherical interior cavity when they are joined together. The mold cavities used to form the outer cover layer have interior dimple cavity details. The cover material conforms to the interior geometry of the mold cavities to form a dimple pattern on the surface of the ball. The injection-mold includes retractable support pins positioned throughout the mold cavities. The retractable support pins move in and out of the cavity. The support pins help maintain the position of the core or ball sub-assembly while molten composition flows through the mold gates. The molten composition flows into the cavity between the core and mold cavities to surround the core and form an intermediate layer or cover layer.

In some embodiments, the polyethylene-based vitrimer or thermoplastic blends including same can be injection molded about the core or other subassembly at temperatures lower than 200° C. (or 392° F.). In other embodiments, the polyethylene-based vitrimer or thermoplastic blends including same can be injection molded about the core or other subassembly at temperatures up to 200° C. In still other embodiments, the polyethylene-based vitrimer or thermoplastic blends including same may be injection molded about the core or other subassembly at temperatures greater than 200° C. Embodiments are also envisioned wherein the injection molding temperature may be from about 190° C. to about 250° C., or from about 190° C. to about 215° C.

In general, compression molding normally involves first making half (hemispherical) shells by injection-molding the composition in an injection mold. This produces semi-cured, semi-rigid half-shells (or cups). Then, the half-shells are positioned in a compression mold around the core or other sub-assembly. Heat and pressure are applied, and the half-shells fuse together to form a cover layer over the core or sub-assembly. Compression molding also can be used to cure the cover composition after injection-molding. For example, a thermally-curable composition can be injection-molded around a core in an unheated mold. After the composition is partially hardened, the ball is removed and placed in a compression mold. Heat and pressure are applied to the ball and this causes thermal-curing of the outer cover layer. A layer of polyethylene-based vitrimer or thermoplastic blend can be compression molded about the subassembly at temperatures for example of from about 120° C. to about 175° C. (about 250° F. to about 350° F.).

Casting is a common method of producing a urethane, urea or urethane/urea hybrid outer layer about a core or other subassembly. A desired benefit of casting golf ball layers about subassemblies is that the resulting layer has a substantially uniform thickness. In a casting process, a castable composition is introduced into a first mold cavity of a given pair of mold half shells. The core/subassembly is then either placed directly into the composition or is held in position (e.g., by an overhanging vacuum or suction apparatus) to contact the material in what will be the spherical center of the mold cavity pair. Once the castable composition is at least partially cured (e.g., to a point where the core will not substantially move), additional castable composition is introduced into a second mold cavity of each pair, and the mold is closed. The closed mold is then subjected to heat and pressure to cure the composition, thereby forming the outer layer about the core. The mold cavities can have smooth surfaces or include a negative dimple pattern to impart dimples in the composition during the molding process where the cast layer is a cover, for example.

It is important that a core/subassembly be centered in the castable composition within a mold cavity before the mold halves are mated because a non-centered core/subassembly can create and result in undesirable playing characteristics. Once the castable outer layer composition achieves a sufficient “degree of cure” the core/subassembly may be centered immovably therein. In conventional castable compositions, the centering time is typically reached once a sufficient degree of polymerization occurs, which prompts viscosity build, and support devices such as pins are commonly used to support the core/subassembly until sufficient cure occurs to center the core/subassembly.

Securing means (such as pins) in the molding equipment hold the core/subassembly in a centered position while the castable compositions develop sufficient viscosity or degree of cure within the mold to center the core/subassembly immovably. Such pin molds generally contain a series of protruding pins designed to secure the core/subassembly concentrically in place within in the layer composition prior to sufficient cure. A predetermined shot weight is dispensed into a pin mold, the core/subassembly is immediately plunged, and the two mold halves are mated. The pins are designed to hold the core/assembly in the correct position while the composition cures to completion, thereby producing a concentrically placed golf ball core/subassembly surrounded by an outer layer. The pins are removed before final cure occurs.

When polyethylene-based vitrimer is blended with one or more thermoplastic polymers, each of the polyethylene-based vitrimer and thermoplastic polymers may be combined as flowable compositions. Alternatively, when at least one polyethylene-based vitrimer is blended with thermoplastic polymers such as ionomers and/or thermoplastic polyurethanes, any or all may be combined as a plurality of particulates before heating sufficiently and molded about the subassembly. A plurality of particulates can be created for each or any of the polyethylene-based vitrimer, ionomer and/or thermoplastic polyurethane by chopping up a given volume thereof into either a greater number of smaller particulates, or a fewer number of larger particulates, or a combination thereof.

A greater number of smaller particulates may be preferred, for example, in order to create a highly homogenous resulting molded layer of blended material. In other embodiments, a fewer number of larger particulates may be preferred in order to create property gradient (e.g., hardness, compression, % neutralization, etc.) within the layer by creating a less homogenous resulting molded layer of each composition of the blend. Embodiments are also envisioned wherein a combination of both smaller particulates and larger particulates may be included in the mixture in various proportions.

For example, in one embodiment, the polyethylene-based vitrimer may be combined in flowable form with particulates of ionomer and/or thermoplastic polyurethane. In other embodiments, particulates of polyethylene-based vitrimer may be combined with the particulates of ionomer and/or thermoplastic polyurethane. In yet other embodiments, particulates of polyethylene-based vitrimer may be combined with a flowable form of the ionomer and/or thermoplastic polyurethane. In still other embodiments, particulates of one polyethylene-based vitrimer and a flowable form of a different polyethylene-based vitrimer may be combined with one or more forms of particulates and/or flowable form ionomer and or thermoplastic polyurethane. In still different embodiments, particulates of and/or flowing polyethylene-based vitrimer may be blended with particulates of and/or flowing millable polyurethane rubber.

Otherwise, golf balls of the invention may have any known construction with the one limitation being that at least one layer of the golf ball comprises or consists of polyethylene-based vitrimer. In one preferred embodiment, the at least one layer of polyethylene-based vitrimer may be an intermediate layer. In another preferred embodiment, the at least one layer is an outer cover layer. However embodiments are indeed envisioned wherein the at least one layer is included in the subassembly and/or even as a film disposed about the subassembly, and/or as a coating formed about the cover.

Golf balls of the invention may be two-piece, three-piece, four-piece, and five-piece constructions or greater, with single or multi-layered cores, and/or single or multi-layered casing layers/intermediate layers, and single or multi-layered covers.

Representative illustrations of such golf ball constructions are provided and discussed further below. The term, “layer” as used herein means generally any spherical of the golf ball. More particularly, in one version, a two-piece golf ball containing a core surrounded by a cover is made.

Two-piece golf balls typically contain a single core and a cover, whereas three-piece golf balls contain a core, intermediate layer and cover or a dual-layered core and single-layered cover. The dual-core includes an inner core (center) and surrounding outer core layer.

In another version, a four-piece golf ball contains a dual-core and dual-cover (inner cover and outer cover layers) is made. In yet another construction, a four-piece or five-piece golf ball containing a dual-core; casing layer(s); and cover layer(s) may be made.

As used herein, the term, “casing layer” can be used interchangeably with intermediate layer to refer to a layer of the ball disposed between the sub-assembly and cover. The casing layer is also sometimes referred to as a mantle layer.

The diameter and thickness of the different layers along with properties such as hardness and compression may vary depending upon wherein the golf ball construction of the invention the at least one layer comprising or consisting of polyethylene-based vitrimer is positioned/located and according to what desired golf ball playing performance properties and characteristics are pre-determined.

In one possible construction, a golf ball of the invention comprises or consists of a single core surrounded by a single layer cover wherein the single layer cover comprises polyethylene-based vitrimer or blends thereof. In this embodiment, the single layer core may comprise a thermoset or thermoplastic material, and embodiments are envisioned wherein the thermoplastic material of the core contains at least some polyethylene-based vitrimer. Advantageously, the hardnesses, CoRs, compressions and of the single core can be pre-selected and coordinated to target desired spin, initial velocity and feel of the resulting golf ball.

In another possible construction, a golf ball of the invention comprises or consists of a core, and intermediate layer and cover, wherein at least one of the intermediate layer and/or the single layer cover comprises polyethylene-based vitrimer or blends thereof. In this embodiment, the single layer core may comprise a thermoset or thermoplastic material, and embodiments are once again envisioned wherein the thermoplastic material of the core contains at least some polyethylene-based vitrimer. Advantageously, the hardnesses, CoRs, compressions and of the core, intermediate layer and cover can be pre-selected and coordinated to target desired spin, initial velocity and feel of the resulting golf ball.

In a four-piece construction, a dual core may be surround by a two-layer cover or by a casing layer and cover. In such embodiments, any of the outer core layer, casing layer and/or cover layer may include at least some polyethylene-based vitrimer, either alone or in a blend with a thermoplastic material such as an ionomer and/or a polyurethane. In such embodiments, each of the inner core and outer core layer may comprise a thermoset composition or a thermoplastic composition. Embodiments are indeed also envisioned wherein the inner core incorporates at least some polyethylene-based vitrimer as well.

Outer cover hardnesses in any golf ball construction typically may range from 20 shore D to 70 Shore D, although it is envisioned that the hardness of the outermost cover layer material can be targeted within any known range by modifying the ingredients of the polymer and relative amounts thereof, as well as by modifying the processing time and temperature.

In particular embodiments, the finished golf ball has a diameter of greater than 1.682 inches. In still other embodiments, the golf ball has a diameter of greater than 1.69 inches, or a diameter of 1.710 inches or greater.

In one version, at least one layer of the subassembly is formed of a rubber composition comprising a rubber material such as, for example, polybutadiene, ethylene-propylene rubber, ethylene-propylene-diene rubber, polyisoprene, styrene-butadiene rubber, polyalkenamers, butyl rubber, halobutyl rubber, or polystyrene elastomers. For example, polybutadiene rubber compositions may be used to form the inner core (center) and surrounding outer core layer in a dual-layer construction. In another version, the core may be formed from an ionomer composition comprising an ethylene acid copolymer containing acid groups such that greater than 70% of the acid groups are neutralized. These highly neutralized polymers (HNPs) also may be used to form at least one core layer in a multi-layered core construction. For example, a polybutadiene rubber composition may be used to form the center and a HNP composition may be used to form the outer core. Such rubber and HNP compositions may be as discussed herein.

In general, polybutadiene is a homopolymer of 1, 3-butadiene. The double bonds in the 1, 3-butadiene monomer are attacked by catalysts to grow the polymer chain and form a polybutadiene polymer having a desired molecular weight. Any suitable catalyst may be used to synthesize the polybutadiene rubber depending upon the desired properties. Normally, a transition metal complex (for example, neodymium, nickel, or cobalt) or an alkyl metal such as alkyllithium is used as a catalyst. Other catalysts include, but are not limited to, aluminum, boron, lithium, titanium, and combinations thereof. The catalysts produce polybutadiene rubbers having different chemical structures. In a cis-bond configuration, the main internal polymer chain of the polybutadiene appears on the same side of the carbon-carbon double bond contained in the polybutadiene. In a trans-bond configuration, the main internal polymer chain is on opposite sides of the internal carbon-carbon double bond in the polybutadiene. The polybutadiene rubber can have various combinations of cis- and trans-bond structures. A preferred polybutadiene rubber has a 1,4 cis-bond content of at least 40%, preferably greater than 80%, and more preferably greater than 90%. In general, polybutadiene rubbers having a high 1,4 cis-bond content have high tensile strength. The polybutadiene rubber may have a relatively high or low Mooney viscosity.

Examples of commercially-available polybutadiene rubbers that can be used in accordance with this invention, include, but are not limited to, BR 01 and BR 1220, available from BST Elastomers of Bangkok, Thailand; SE BR 1220LA and SE BR1203, available from DOW Chemical Co of Midland, Mich.; BUDENE 1207, 1207s, 1208, and 1280 available from Goodyear, Inc of Akron, Ohio; BR 01, 51 and 730, available from Japan Synthetic Rubber (JSR) of Tokyo, Japan; BUNA CB 21, CB 22, CB 23, CB 24, CB 25, CB 29 MES, CB 60, CB Nd 60, CB 55 NF, CB 70 B, CB KA 8967, and CB 1221, available from Lanxess Corp. of Pittsburgh. Pa.; BR1208, available from LG Chemical of Seoul, South Korea; UBEPOL BR130B, BR150, BR150B, BR150L, BR230, BR360L, BR710, and VCR617, available from UBE Industries, Ltd. of Tokyo, Japan; EUROPRENE NEOCIS BR 60, INTENE 60 AF and P30AF, and EUROPRENE BR HV80, available from Polimeri Europa of Rome, Italy; AFDENE 50 and NEODENE BR40, BR45, BR50 and BR60, available from Karbochem (PTY) Ltd. of Bruma, South Africa; KBR 01, NdBr 40, NdBR-45, NdBr 60, KBR 710S, KBR 710H, and KBR 750, available from Kumho Petrochemical Co., Ltd. Of Seoul, South Korea; and DIENE 55NF, 70AC, and 320 AC, available from Firestone Polymers of Akron, Ohio.

To form the core, the polybutadiene rubber is used in an amount of at least about 5% by weight based on total weight of composition and is generally present in an amount of about 5% to about 100%, or an amount within a range having a lower limit of 5% or 10% or 20% or 30% or 40% or 50% and an upper limit of 55% or 60% or 70% or 80% or 90% or 95% or 100%. In general, the concentration of polybutadiene rubber is about 45 to about 95 weight percent. Preferably, the rubber material used to form the core layer comprises at least 50% by weight, and more preferably at least 70% by weight, polybutadiene rubber.

The rubber compositions of this invention may be cured, either by pre-blending or post-blending, using conventional curing processes. Suitable curing processes include, for example, peroxide-curing, sulfur-curing, high-energy radiation, and combinations thereof. Preferably, the rubber composition contains a free-radical initiator selected from organic peroxides, high energy radiation sources capable of generating free-radicals, and combinations thereof. In one preferred version, the rubber composition is peroxide-cured. Suitable organic peroxides include, but are not limited to, dicumyl peroxide; n-butyl-4,4-di(t-butylperoxy) valerate; 1,1-di(t-butylperoxy)3,3,5-trimethylcyclohexane; 2,5-dimethyl-2,5-di(t-butylperoxy) hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; and combinations thereof. In a particular embodiment, the free radical initiator is dicumyl peroxide, including, but not limited to Perkadox® BC, commercially available from Akzo Nobel. Peroxide free-radical initiators are generally present in the rubber composition in an amount of at least 0.05 parts by weight per 100 parts of the total rubber, or an amount within the range having a lower limit of 0.05 parts or 0.1 parts or 1 part or 1.25 parts or 1.5 parts or 2.5 parts or 5 parts by weight per 100 parts of the total rubbers, and an upper limit of 2.5 parts or 3 parts or 5 parts or 6 parts or 10 parts or 15 parts by weight per 100 parts of the total rubber. Concentrations are in parts per hundred (phr) unless otherwise indicated. As used herein, the term, “parts per hundred,” also known as “phr” or “pph” is defined as the number of parts by weight of a particular component present in a mixture, relative to 100 parts by weight of the polymer component. Mathematically, this can be expressed as the weight of an ingredient divided by the total weight of the polymer, multiplied by a factor of 100.

The rubber compositions preferably include a reactive cross-linking co-agent. Suitable co-agents include, but are not limited to, metal salts of unsaturated carboxylic acids having from 3 to 8 carbon atoms; unsaturated vinyl compounds and polyfunctional monomers (e.g., trimethylolpropane trimethacrylate); phenylene bismaleimide; and combinations thereof. Particular examples of suitable metal salts include, but are not limited to, one or more metal salts of acrylates, diacrylates, methacrylates, and dimethacrylates, wherein the metal is selected from magnesium, calcium, zinc, aluminum, lithium, and nickel. In a particular embodiment, the co-agent is selected from zinc salts of acrylates, diacrylates, methacrylates, and dimethacrylates. In another particular embodiment, the agent is zinc diacrylate (ZDA). When the co-agent is zinc diacrylate and/or zinc dimethacrylate, the co-agent is typically included in the rubber composition in an amount within the range having a lower limit of 1 or 5 or 10 or 15 or 19 or 20 parts by weight per 100 parts of the total rubber, and an upper limit of 24 or 25 or 30 or 35 or 40 or 45 or 50 or 60 parts by weight per 100 parts of the base rubber.

Radical scavengers such as a halogenated organosulfur or metal salt thereof, organic disulfide, or inorganic disulfide compounds may be added to the rubber composition. These compounds also may function as “soft and fast agents.” As used herein, “soft and fast agent” means any compound or a blend thereof that is capable of making a core: 1) softer (having a lower compression) at a constant “coefficient of restitution” (COR); and/or 2) faster (having a higher COR at equal compression), when compared to a core equivalently prepared without a soft and fast agent. Preferred halogenated organosulfur compounds include, but are not limited to, pentachlorothiophenol (PCTP) and salts of PCTP such as zinc pentachlorothiophenol (ZnPCTP). Using PCTP and ZnPCTP in golf ball inner cores helps produce softer and faster inner cores. The PCTP and ZnPCTP compounds help increase the resiliency and the coefficient of restitution of the core. In a particular embodiment, the soft and fast agent is selected from ZnPCTP, PCTP, ditolyl disulfide, diphenyl disulfide, dixylyl disulfide, 2-nitroresorcinol, and combinations thereof.

The rubber compositions of the present invention also may include “fillers,” which are added to adjust the density and/or specific gravity of the material. Suitable fillers include, but are not limited to, polymeric or mineral fillers, metal fillers, metal alloy fillers, metal oxide fillers and carbonaceous fillers. The fillers can be in any suitable form including, but not limited to, flakes, fibers, whiskers, fibrils, plates, particles, and powders. Rubber regrind, which is ground, recycled rubber material (for example, ground to about 30 mesh particle size) obtained from discarded rubber golf ball cores, also can be used as a filler. The amount and type of fillers utilized are governed by the amount and weight of other ingredients in the golf ball, since a maximum golf ball weight of 45.93 g (1.62 ounces) has been established by the United States Golf Association (USGA).

Suitable polymeric or mineral fillers that may be added to the rubber composition include, for example, precipitated hydrated silica, clay, talc, asbestos, glass fibers, aramid fibers, mica, calcium metasilicate, barium sulfate, zinc sulfide, lithopone, silicates, silicon carbide, tungsten carbide, diatomaceous earth, polyvinyl chloride, carbonates such as calcium carbonate and magnesium carbonate. Suitable metal fillers include titanium, tungsten, aluminum, bismuth, nickel, molybdenum, iron, lead, copper, boron, cobalt, beryllium, zinc, and tin. Suitable metal alloys include steel, brass, bronze, boron carbide whiskers, and tungsten carbide whiskers. Suitable metal oxide fillers include zinc oxide, iron oxide, aluminum oxide, titanium oxide, magnesium oxide, and zirconium oxide. Suitable particulate carbonaceous fillers include graphite, carbon black, cotton flock, natural bitumen, cellulose flock, and leather fiber. Micro balloon fillers such as glass and ceramic, and fly ash fillers can also be used. In a particular aspect of this embodiment, the rubber composition includes filler(s) selected from carbon black, nanoclays (e.g., Cloisite® and Nanofil® nanoclays, commercially available from Southern Clay Products, Inc., and Nanomax® and Nanomer® nanoclays, commercially available from Nanocor, Inc.), talc (e.g., Luzenac HAR® high aspect ratio talcs, commercially available from Luzenac America, Inc.), glass (e.g., glass flake, milled glass, and microglass), mica and mica-based pigments (e.g., Iriodin® pearl luster pigments, commercially available from The Merck Group), and combinations thereof. In a particular embodiment, the rubber composition is modified with organic fiber micropulp.

In addition, the rubber compositions may include antioxidants to prevent the breakdown of the elastomers. Also, processing aids such as high molecular weight organic acids and salts thereof, may be added to the composition. In a particular embodiment, the total amount of additive(s) and filler(s) present in the rubber composition is 15 wt % or less, or 12 wt % or less, or 10 wt % or less, or 9 wt % or less, or 6 wt % or less, or 5 wt % or less, or 4 wt % or less, or 3 wt % or less, based on the total weight of the rubber composition.

The polybutadiene rubber material (base rubber) may be blended with other elastomers in accordance with this invention. Other elastomers include, but are not limited to, polybutadiene, polyisoprene, ethylene propylene rubber (“EPR”), styrene-butadiene rubber, styrenic block copolymer rubbers (such as “SI”, “SIS”, “SB”, “SBS”, “SIBS”, and the like, where “S” is styrene, “I” is isobutylene, and “B” is butadiene), polyalkenamers such as, for example, polyoctenamer, butyl rubber, halobutyl rubber, polystyrene elastomers, polyethylene elastomers, polyurethane elastomers, polyurea elastomers, metallocene-catalyzed elastomers and plastomers, copolymers of isobutylene and p-alkylstyrene, halogenated copolymers of isobutylene and p-alkylstyrene, copolymers of butadiene with acrylonitrile, polychloroprene, alkyl acrylate rubber, chlorinated isoprene rubber, acrylonitrile chlorinated isoprene rubber, and combinations of two or more thereof.

The polymers, free-radical initiators, filler, cross-linking agents, and any other materials used in forming either the golf ball center or any of the core, in accordance with invention, may be combined to form a mixture by any type of mixing known to one of ordinary skill in the art. Suitable types of mixing include single pass and multi-pass mixing, and the like. The cross-linking agent, and any other optional additives used to modify the characteristics of the golf ball center or additional layer(s), may similarly be combined by any type of mixing. A single-pass mixing process where ingredients are added sequentially is preferred, as this type of mixing tends to increase efficiency and reduce costs for the process. The preferred mixing cycle is single step wherein the polymer, cis-to-trans catalyst, filler, zinc diacrylate, and peroxide are added in sequence.

In one preferred embodiment, the entire core or at least one core layer in a multi-layered structure is formed of a rubber composition comprising a material selected from the group of natural and synthetic rubbers including, but not limited to, polybutadiene, polyisoprene, ethylene propylene rubber (“EPR”), ethylene-propylene-diene (“EPDM”) rubber, styrene-butadiene rubber, styrenic block copolymer rubbers (such as “SI”, “SIS”, “SB”, “SBS”, “SIBS”, and the like, where “S” is styrene, “I” is isobutylene, and “B” is butadiene), polyalkenamers such as, for example, polyoctenamer, butyl rubber, halobutyl rubber, polystyrene elastomers, polyethylene elastomers, polyurethane elastomers, polyurea elastomers, metallocene-catalyzed elastomers and plastomers, copolymers of isobutylene and p-alkylstyrene, halogenated copolymers of isobutylene and p-alkylstyrene, copolymers of butadiene with acrylonitrile, polychloroprene, alkyl acrylate rubber, chlorinated isoprene rubber, acrylonitrile chlorinated isoprene rubber, and combinations of two or more thereof.

In a golf ball of the invention made by a method of the invention, conventional compression and injection-molding and other methods can be used to pre-mold cover layers over the core or ball sub-assembly with at least one modification being that the molds will have smooth inner surfaces rather than having a dimple pattern contoured inner surface. In general, compression molding normally involves first making half (hemispherical) shells by injection-molding the composition in an injection mold. This produces semi-cured, semi-rigid half-shells (or cups). Then, the half-shells are positioned in a compression mold around the core or ball sub-assembly. Heat and pressure are applied and the half-shells fuse together to form a cover layer over the core or sub-assembly. Compression molding also can be used to cure the cover composition after injection-molding. For example, a thermally-curable composition can be injection-molded around a core in an unheated mold. After the composition is partially hardened, the ball is removed and placed in a compression mold. Heat and pressure are applied to the ball and this causes thermal-curing of the outer cover layer.

Retractable pin injection-molding (RPIM) methods generally involve using upper and lower mold cavities that are mated together. The upper and lower mold cavities form a spherical interior cavity when they are joined together. The mold cavities used to form the outer cover layer have interior dimple cavity details. The cover material conforms to the interior geometry of the mold cavities to form a dimple pattern on the surface of the ball. The injection-mold includes retractable support pins positioned throughout the mold cavities. The retractable support pins move in and out of the cavity. The support pins help maintain the position of the core or ball sub-assembly while the molten composition flows through the mold gates. The molten composition flows into the cavity between the core and mold cavities to surround the core and form the cover layer. Other methods can be used to make the cover including, for example, reaction injection-molding (RIM), liquid injection-molding, casting, spraying, powder-coating, vacuum-forming, flow-coating, dipping, spin-coating, and the like.

As discussed above, an inner cover layer or intermediate layer, preferably formed from an ethylene acid copolymer ionomer composition, can be part of the subassembly. The layer comprising ionomer may be an outermost layer of the subassembly and adjacent the thermoplastic cover. This layer may be formed using conventional technique such as, for example, compression or injection-molding. For example, the ionomer composition may be injection-molded or placed in a compression mold to produce half-shells. These shells are placed around the core in a compression mold, and the shells fuse together to form an intermediate layer. Alternatively, the ionomer composition is injection-molded directly onto the core using retractable pin injection-molding.

After the golf balls have been removed from the mold, they may be subjected to any necessary finishing steps such as flash-trimming or surface-treatment, each which should be reduced, or marking, and/or providing any desired coating layer which may be applied via methods such as spraying, dipping, brushing, or rolling. For example, in traditional white-colored golf balls, the white-pigmented outer cover layer may be surface-treated using a suitable method such as, for example, corona, plasma, or ultraviolet (UV) light-treatment. In another finishing process, the golf balls are painted with one or more paint coatings. For example, white or clear primer paint may be applied first to the surface of the ball and then indicia may be applied over the primer followed by application of a clear polyurethane top-coat. Indicia such as trademarks, symbols, logos, letters, and the like may be printed on the outer cover or prime-coated layer, or top-coated layer using pad-printing, ink-jet printing, dye-sublimation, or other suitable printing methods. Any of the surface coatings may contain a fluorescent optical brightener.

The golf balls produced by a method of this invention provide a variety of advantageous mechanical and playing performance properties as discussed further below. In general, the hardness, diameter, and thickness of the different ball layers may vary depending upon the desired ball construction desired playing characteristics. Thus, golf balls of the invention may have any known overall diameter and any known number of different layers and layer thicknesses, with the limitation being that at least one layer of the golf ball incorporates polyethylene-based vitrimer.

That being said, the core may for example have a diameter ranging from about 0.09 inches to less than about 1.7 inches. In one embodiment, the diameter of the core of the present invention is about 1.2 inches to about 1.630 inches. When part of a two-piece ball according to invention, the core may have a diameter ranging from about 1.5 inches to about 1.62 inches. In another embodiment, the diameter of the core is about 1.3 inches to about 1.6 inches, preferably from about 1.39 inches to about 1.6 inches, and more preferably from about 1.5 inches to about 1.6 inches. In yet another embodiment, the core has a diameter of about 1.55 inches to about 1.65 inches, preferably about 1.55 inches to about 1.60 inches.

In some embodiments, the core may have an overall diameter within a range having a lower limit of 0.500 or 0.700 or 0.750 or 0.800 or 0.850 or 0.900 or 0.950 or 1.000 or 1.100 or 1.150 or 1.200 or 1.250 or 1.300 or 1.350 or 1.400 or 1.450 or 1.500 or 1.600 or 1.610 inches and an upper limit of 1.620 or 1.630 or 1.640 inches or less than 1.7 inches. In a particular embodiment, the core is a multi-layer core having an overall diameter within a range having a lower limit of 0.500 or 0.700 or 0.750 or 0.800 or 0.850 or 0.900 or 0.950 or 1.000 or 1.100 or 1.150 or 1.200 inches and an upper limit of 1.250 or 1.300 or 1.350 or 1.400 or 1.450 or 1.500 or 1.600 or 1.610 or 1.620 or 1.630 or 1.640 inches. In another particular embodiment, the multi-layer core has an overall diameter within a range having a lower limit of 0.500 or 0.700 or 0.750 inches and an upper limit of 0.800 or 0.850 or 0.900 or 0.950 or 1.000 or 1.100 or 1.150 or 1.200 or 1.250 or 1.300 or 1.350 or 1.400 or 1.450 or 1.500 or 1.600 or 1.610 or 1.620 or 1.630 or 1.640 inches or about 1.7 inches. In another particular embodiment, the multi-layer core has an overall diameter of 1.500 inches or 1.510 inches or 1.530 inches or 1.550 inches or 1.570 inches or 1.580 inches or 1.590 inches or 1.600 inches or 1.610 inches or 1.620 inches.

In some embodiments, the inner core can have an overall diameter of 0.500 inches or greater, or 0.700 inches or greater, or 1.00 inches or greater, or 1.250 inches or greater, or 1.350 inches or greater, or 1.390 inches or greater, or 1.450 inches or greater, or an overall diameter within a range having a lower limit of 0.250 or 0.500 or 0.750 or 1.000 or 1.250 or 1.350 or 1.390 or 1.400 or 1.440 inches and an upper limit of 1.460 or 1.490 or 1.500 or 1.550 or 1.580 or 1.600 inches, or an overall diameter within a range having a lower limit of 0.250 or 0.300 or 0.350 or 0.400 or 0.500 or 0.550 or 0.600 or 0.650 or 0.700 inches and an upper limit of 0.750 or 0.800 or 0.900 or 0.950 or 1.000 or 1.100 or 1.150 or 1.200 or 1.250 or 1.300 or 1.350 or 1.400 inches.

In some embodiments, the outer core layer can have an overall thickness within a range having a lower limit of 0.010 or 0.020 or 0.025 or 0.030 or 0.035 inches and an upper limit of 0.040 or 0.070 or 0.075 or 0.080 or 0.100 or 0.150 inches, or an overall thickness within a range having a lower limit of 0.025 or 0.050 or 0.100 or 0.150 or 0.160 or 0.170 or 0.200 inches and an upper limit of 0.225 or 0.250 or 0.275 or 0.300 or 0.325 or 0.350 or 0.400 or 0.450 or greater than 0.450 inches. The outer core layer may alternatively have a thickness of greater than 0.10 inches, or 0.20 inches or greater, or greater than 0.20 inches, or 0.30 inches or greater, or greater than 0.30 inches, or 0.35 inches or greater, or greater than 0.35 inches, or 0.40 inches or greater, or greater than 0.40 inches, or 0.45 inches or greater, or greater than 0.45 inches, or a thickness within a range having a lower limit of 0.005 or 0.010 or 0.015 or 0.020 or 0.025 or 0.030 or 0.035 or 0.040 or 0.045 or 0.050 or 0.055 or 0.060 or 0.065 or 0.070 or 0.075 or 0.080 or 0.090 or 0.100 or 0.200 or 0.250 inches and an upper limit of 0.300 or 0.350 or 0.400 or 0.450 or 0.500 or 0.750 inches.

An intermediate core layer can have any known overall thickness such as within a range having a lower limit of 0.005 or 0.010 or 0.015 or 0.020 or 0.025 or 0.030 or 0.035 or 0.040 or 0.045 inches and an upper limit of 0.050 or 0.055 or 0.060 or 0.065 or 0.070 or 0.075 or 0.080 or 0.090 or 0.100 inches.

The cores and core layers of golf balls of the invention may have varying hardnesses depending on the particular golf ball construction and playing characteristics being targeted. Core center and/or layer hardness can range, for example, from 35 Shore C to about 98 Shore C, or 50 Shore C to about 90 Shore C, or 60 Shore C to about 85 Shore C, or 45 Shore C to about 75 Shore C, or 40 Shore C to about 85 Shore C. In other embodiments, core center and/or layer hardness can range, for example, from about 20 Shore D to about 78 Shore D, or from about 30 Shore D to about 60 Shore D, or from about 40 Shore D to about 50 Shore D, or 50 Shore D or less, or greater than 50 Shore D.

The compression of the core is generally overall in the range of about 40 to about 110, although embodiments are envisioned wherein the compression of the core is as low as 5. In other embodiments, the overall CoR of cores of the present invention at 125 ft/s is at least 0.750, or at least 0.775 or at least 0.780, or at least 0.785, or at least 0.790, or at least 0.795, or at least 0.800. Cores are also known to comprise rubbers and also may be formed of a variety of other materials that are typically also used for intermediate and cover layers. Intermediate layers may likewise also comprise materials generally used in cores and covers as described herein for example.

An intermediate layer is sometimes thought of as including any layer(s) disposed between the inner core (or center) and the outer cover of a golf ball, and thus in some embodiments, the intermediate layer may include an outer core layer, a casing layer, or inner cover layer(s). In this regard, a golf ball of the invention may include one or more intermediate layers. An intermediate layer may be used, if desired, with a multilayer cover or a multilayer core, or with both a multilayer cover and a multilayer core.

In one non-limiting embodiment, an intermediate layer having a thickness of about 0.010 inches to about 0.06 inches, is disposed about a core having a diameter ranging from about 1.5 inches to about 1.59 inches.

Non-limiting examples of other suitable materials include one or more homopolymeric or copolymeric materials, such as primarily or fully non-ionomeric thermoplastic materials, vinyl resins, polyolefins, polyamides, acrylic resins and blends thereof, olefinic thermoplastic rubbers, block copolymers of styrene and butadiene, isoprene or ethylene-butylene rubber, copoly(ether-amide), polyphenylene oxide resins or blends thereof, and thermoplastic polyesters. However, embodiments are envisioned wherein yet different materials commonly used in a core and/or intermediate layers and/or cover layers.

The range of thicknesses for an intermediate layer of a golf ball is large because of the vast possibilities when using an intermediate layer, i.e., as an outer core layer, an inner cover layer, a wound layer, a moisture/vapor barrier layer. When used in a golf ball of the present invention, the intermediate layer, or inner cover layer, may have a thickness about 0.3 inches or less. In one embodiment, the thickness of the intermediate layer is from about 0.002 inches to about 0.1 inches, and preferably about 0.01 inches or greater. For example, when part of a three-piece ball or multi-layer ball according to the invention, the intermediate layer and/or inner cover layer may have a thickness ranging from about 0.010 inches to about 0.06 inches. In another embodiment, the intermediate layer thickness is about 0.05 inches or less, or about 0.01 inches to about 0.045 inches for example.

If the ball includes an intermediate layer or inner cover layer, the hardness (material) may for example be about 50 Shore D or greater, more preferably about 55 Shore D or greater, and most preferably about 60 Shore D or greater. In one embodiment, the inner cover has a Shore D hardness of about 62 to about 90 Shore D. In one example, the inner cover has a hardness of about 68 Shore D or greater. In addition, the thickness of the inner cover layer is preferably about 0.015 inches to about 0.100 inches, more preferably about 0.020 inches to about 0.080 inches, and most preferably about 0.030 inches to about 0.050 inches, but once again, may be changed to target playing characteristics.

The cover typically has a thickness to provide sufficient strength, good performance characteristics, and durability. In one embodiment, the cover thickness may for example be from about 0.02 inches to about 0.12 inches, or about 0.1 inches or less. For example, the cover may be part of a two-piece golf ball and have a thickness ranging from about 0.03 inches to about 0.09 inches. In another embodiment, the cover thickness may be about 0.05 inches or less, or from about 0.02 inches to about 0.05 inches, or from about 0.02 inches and about 0.045 inches.

The cover may be a single-, dual-, or multi-layer cover and have an overall thickness for example within a range having a lower limit of 0.010 or 0.020 or 0.025 or 0.030 or 0.040 or 0.045 inches and an upper limit of 0.050 or 0.060 or 0.070 or 0.075 or 0.080 or 0.090 or 0.100 or 0.150 or 0.200 or 0.300 or 0.500 inches. In a particular embodiment, the cover may be a single layer having a thickness of from 0.010 or 0.020 or 0.025 inches to 0.035 or 0.040 or 0.050 inches. In another particular embodiment, the cover may consist of an inner cover layer having a thickness of from 0.010 or 0.020 or 0.025 inches to 0.035 or 0.050 inches and an outer cover layer having a thickness of from 0.010 or 0.020 or 0.025 inches to 0.035 or 0.040 inches. The outer cover preferably has a thickness within a range having a lower limit of about 0.004 or 0.010 or 0.020 or 0.030 or 0.040 inches and an upper limit of about 0.050 or 0.055 or 0.065 or 0.070 or 0.080 inches. Preferably, the thickness of the outer cover is about 0.020 inches or less. The outer cover preferably has a surface hardness of 75 Shore D or less, 65 Shore D or less, or 55 Shore D or less, or 50 Shore D or less, or 50 Shore D or less, or 45 Shore D or less. Preferably, the outer cover has hardness in the range of about 20 to about 70 Shore D. In one example, the outer cover has hardness in the range of about 25 to about 65 Shore D.

In one embodiment, the cover may be a single layer having a surface hardness for example of 60 Shore D or greater, or 65 Shore D or greater. In a particular aspect of this embodiment, the cover is formed from a composition having a material hardness of 60 Shore D or greater, or 65 Shore D or greater.

In another particular embodiment, the cover may be a single layer having a thickness of from 0.010 or 0.020 inches to 0.035 or 0.050 inches and formed from a composition having a material hardness of from 60 or 62 or 65 Shore D to 65 or 70 or 72 Shore D.

In yet another particular embodiment, the cover is a single layer having a thickness of from 0.010 or 0.025 inches to 0.035 or 0.040 inches and formed from a composition having a material hardness of 62 Shore D or less, or less than 62 Shore D, or 60 Shore D or less, or less than 60 Shore D, or 55 Shore D or less, or less than 55 Shore D.

In still another particular embodiment, the cover is a single layer having a thickness of from 0.010 or 0.025 inches to 0.035 or 0.040 inches and formed from a composition having a material hardness of 62 Shore D or less, or less than 62 Shore D, or 60 Shore D or less, or less than 60 Shore D, or 55 Shore D or less, or less than 55 Shore D.

In an alternative embodiment, the cover may comprise an inner cover layer and an outer cover layer. The inner cover layer composition may have a material hardness of from 60 or 62 or 65 Shore D to 65 or 70 or 72 Shore D. The inner cover layer may have a thickness within a range having a lower limit of 0.010 or 0.020 or 0.030 inches and an upper limit of 0.035 or 0.040 or 0.050 inches. The outer cover layer composition may have a material hardness of 62 Shore D or less, or less than 62 Shore D, or 60 Shore D or less, or less than 60 Shore D, or 55 Shore D or less, or less than 55 Shore D. The outer cover layer may have a thickness within a range having a lower limit of 0.010 or 0.020 or 0.025 inches and an upper limit of 0.035 or 0.040 or 0.050 inches.

In yet another embodiment, the cover is a dual- or multi-layer cover including an inner or intermediate cover layer and an outer cover layer. The inner cover layer may have a surface hardness of 70 Shore D or less, or 65 Shore D or less, or less than 65 Shore D, or a Shore D hardness of from 50 to 65, or a Shore D hardness of from 57 to 60, or a Shore D hardness of 58, and a thickness within a range having a lower limit of 0.010 or 0.020 or 0.030 inches and an upper limit of 0.045 or 0.080 or 0.120 inches. The outer cover layer may have a material hardness of 65 Shore D or less, or 55 Shore D or less, or 45 Shore D or less, or 40 Shore D or less, or from 25 Shore D to 40 Shore D, or from 30 Shore D to 40 Shore D. The outer cover layer may have a surface hardness within a range having a lower limit of 20 or 30 or 35 or 40 Shore D and an upper limit of 52 or 58 or 60 or 65 or 70 or 72 or 75 Shore D. The outer cover layer may have a thickness within a range having a lower limit of 0.010 or 0.015 or 0.025 inches and an upper limit of 0.035 or 0.040 or 0.045 or 0.050 or 0.055 or 0.075 or 0.080 or 0.115 inches.

It is envisioned that golf balls of the invention may also incorporate conventional coating layer(s) for the purposes usually incorporated. For example, one or more coating layer may have a combined thickness of from about 0.1 μm to about 100 μm, or from about 2 μm to about 50 μm, or from about 2 μm to about 30 μm. Meanwhile, each coating layer may have a thickness of from about 0.1 μm to about 50 μm, or from about 0.1 μm to about 25 μm, or from about 0.1 μm to about 14 μm, or from about 2 μm to about 9 μm, for example.

The resulting balls of this invention have good impact durability and cut/shear-resistance. The United States Golf Association (“USGA”) has set total weight limits for golf balls. Particularly, the USGA has established a maximum weight of 45.93 g (1.62 ounces) for golf balls. There is no lower weight limit. In addition, the USGA requires that golf balls used in competition have a diameter of at least 1.68 inches. There is no upper limit so many golf balls have an overall diameter falling within the range of about 1.68 to about 1.80 inches. The golf ball diameter is preferably about 1.68 to 1.74 inches, more preferably about 1.68 to 1.70 inches. In accordance with the present invention, the weight, diameter, and thickness of the core and cover layers may be adjusted, as needed, so the ball meets USGA specifications of a maximum weight of 1.62 ounces and a minimum diameter of at least 1.68 inches.

Preferably, the golf ball has a Coefficient of Restitution (CoR) of at least 0.750 and more preferably at least 0.800 (as measured per the test methods below). The core of the golf ball generally has a compression in the range of about 30 to about 130 and more preferably in the range of about 70 to about 110 (as measured per the test methods below.) These properties allow players to generate greater ball velocity off the tee and achieve greater distance with their drives. At the same time, the relatively thin outer cover layer means that a player will have a more comfortable and natural feeling when striking the ball with a club. The ball is more playable and its flight path can be controlled more easily. This control allows the player to make better approach shots near the green. Furthermore, the outer covers of this invention have good impact durability and mechanical strength.

The following test methods may be used to obtain or determine certain properties in connection with materials of golf balls constructed in accordance with a method of the invention.

### Melt Flow Index

The melt flow rate characterizes the resistance to flow of a molten plastic material and can be determined, for example, in accordance with ASTM Standard D1238 and ISO 1133, and for example, using a Tinius-Olsen Extrusion Plastometer. The quantity of melt flow is measured by placing the sample in a heated barrel where it is held for a certain time then forced through a die using a weighted piston. The ASTM standard specifies the barrel and die dimensions and suggests a number of temperature and weight conditions typically chosen to give results between 0.15 and 50 g/10 min. Melt flow results are reported as grams of material extruded over a 10-minute time interval at a specified temperature and load.

Melt flow analysis can be done using a 190° C./2.16 kg condition and/or a 190° C./10 kg condition. Generally, materials should be compared to each other under identical melt flow conditions. In some cases, however, information can be obtained by comparing melt flow values under different conditions. For example, a material that has a melt flow of 3.0 g/10 minutes at 280° C./10 kg flows less than a material that has the same melt flow at 190° C./2.16 kg. Melt flow conditions can be useful in determining molding conditions for each material and as a predictor of over-molding success or failure.

Hardness The center hardness of a core is obtained according to the following procedure. The core is gently pressed into a hemispherical holder having an internal diameter approximately slightly smaller than the diameter of the core, such that the core is held in place in the hemispherical of the holder while concurrently leaving the geometric central plane of the core exposed. The core is secured in the holder by friction, such that it will not move during the cutting and grinding steps, but the friction is not so excessive that distortion of the natural shape of the core would result. The core is secured such that the parting line of the core is roughly parallel to the top of the holder. The diameter of the core is measured 90 degrees to this orientation prior to securing. A measurement is also made from the bottom of the holder to the top of the core to provide a reference point for future calculations. A rough cut is made slightly above the exposed geometric center of the core using a band saw or other appropriate cutting tool, making sure that the core does not move in the holder during this step. The remainder of the core, still in the holder, is secured to the base plate of a surface grinding machine. The exposed ‘rough’ surface is ground to a smooth, flat surface, revealing the geometric center of the core, which can be verified by measuring the height from the bottom of the holder to the exposed surface of the core, making sure that exactly half of the original height of the core, as measured above, has been removed to within 0.004 inches. Leaving the core in the holder, the center of the core is found with a center square and carefully marked and the hardness is measured at the center mark according to ASTM D-2240. Additional hardness measurements at any distance from the center of the core can then be made by drawing a line radially outward from the center mark, and measuring the hardness at any given distance along the line, typically in 2 mm increments from the center. The hardness at a particular distance from the center should be measured along at least two, preferably four, radial arms located 180° apart, or 90° apart, respectively, and then averaged. All hardness measurements performed on a plane passing through the geometric center are performed while the core is still in the holder and without having disturbed its orientation, such that the test surface is constantly parallel to the bottom of the holder, and thus also parallel to the properly aligned foot of the durometer.

The outer surface hardness of a golf ball layer is measured on the actual outer surface of the layer and is obtained from the average of a number of measurements taken from opposing hemispheres, taking care to avoid making measurements on the parting line of the core or on surface defects, such as holes or protrusions. Hardness measurements are made pursuant to ASTM D-2240 “Indentation Hardness of Rubber and Plastic by Means of a Durometer.” Because of the curved surface, care must be taken to ensure that the golf ball or golf ball sub-assembly is centered under the durometer indenter before a surface hardness reading is obtained. A calibrated, digital durometer, capable of reading to 0.1 hardness units is used for the hardness measurements. The digital durometer must be attached to, and its foot made parallel to, the base of an automatic stand. The weight on the durometer and attack rate conforms to ASTM D-2240.

In certain embodiments, a point or plurality of points measured along the “positive” or “negative” gradients may be above or below a line fit through the gradient and its outermost and innermost hardness values. In an alternative preferred embodiment, the hardest point along a particular steep “positive” or “negative” gradient may be higher than the value at the innermost of the inner core (the geometric center) or outer core layer (the inner surface)—as long as the outermost point (i.e., the outer surface of the inner core) is greater than (for “positive”) or lower than (for “negative”) the innermost point (i.e., the geometric center of the inner core or the inner surface of the outer core layer), such that the “positive” and “negative” gradients remain intact.

As discussed above, the direction of the hardness gradient of a golf ball layer is defined by the difference in hardness measurements taken at the outer and inner surfaces of a particular layer. The center hardness of an inner core and hardness of the outer surface of an inner core in a single-core ball or outer core layer are readily determined according to the test procedures provided above. The outer surface of the inner core layer (or other optional intermediate core layers) in a dual-core ball are also readily determined according to the procedures given herein for measuring the outer surface hardness of a golf ball layer, if the measurement is made prior to surrounding the layer with an additional core layer. Once an additional core layer surrounds a layer of interest, the hardness of the inner and outer surfaces of any inner or intermediate layers can be difficult to determine. Therefore, for purposes of the present invention, when the hardness of the inner or outer surface of a core layer is needed after the inner layer has been surrounded with another core layer, the test procedure described above for measuring a point located 1 mm from an interface is used.

Also, it should be understood that there is a fundamental difference between “material hardness” and “hardness as measured directly on a golf ball.” For purposes of the present invention, material hardness is measured according to ASTM D2240 and generally involves measuring the hardness of a flat “slab” or “button” formed of the material. Surface hardness as measured directly on a golf ball (or other spherical surface) typically results in a different hardness value. The difference in “surface hardness” and “material hardness” values is due to several factors including, but not limited to, ball construction (that is, core type, number of cores and/or cover layers, and the like); ball (or sphere) diameter; and the material composition of adjacent layers. It also should be understood that the two measurement techniques are not linearly related and, therefore, one hardness value cannot easily be correlated to the other. Shore hardness (for example, Shore C or Shore D or Shore A hardness) was measured according to the test method ASTM D-2240.

Compression As disclosed in Jeff Dalton's Compression by Any Other Name, Science and Golf IV, Proceedings of the World Scientific Congress of Golf (Eric Thain ed., Routledge, 2002) (“J. Dalton”), several different methods can be used to measure compression, including Atti compression, Riehle compression, load/deflection measurements at a variety of fixed loads and offsets, and effective modulus. For purposes of the present invention, compression refers to Soft Center Deflection Index (“SCDI”). The SCDI is a program change for the Dynamic Compression Machine (“DCM”) that allows determination of the pounds required to deflect a core 10% of its diameter. The DCM is an apparatus that applies a load to a core or ball and measures the number of inches the core or ball is deflected at measured loads. A crude load/deflection curve is generated that is fit to the Atti compression scale that results in a number being generated that represents an Atti compression. The DCM does this via a load cell attached to the bottom of a hydraulic cylinder that is triggered pneumatically at a fixed rate (typically about 1.0 ft/s) towards a stationary core. Attached to the cylinder is an LVDT that measures the distance the cylinder travels during the testing timeframe. A software-based logarithmic algorithm ensures that measurements are not taken until at least five successive increases in load are detected during the initial phase of the test. The SCDI is a slight variation of this set up. The hardware is the same, but the software and output has changed. With the SCDI, the interest is in the pounds of force required to deflect a core x amount of inches. That amount of deflection is 10% percent of the core diameter. The DCM is triggered, the cylinder deflects the core by 10% of its diameter, and the DCM reports back the pounds of force required (as measured from the attached load cell) to deflect the core by that amount. The value displayed is a single number in units of pounds.
Coefficient of Restitution (“CoR”) The CoR is determined according to a known procedure, wherein a golf ball or golf ball sub-assembly (for example, a golf ball core) is fired from an air cannon at two given velocities and a velocity of 125 ft/s is used for the calculations. Ballistic light screens are located between the air cannon and steel plate at a fixed distance to measure ball velocity. As the ball travels toward the steel plate, it activates each light screen and the ball's time period at each light screen is measured. This provides an incoming transit time period which is inversely proportional to the ball's incoming velocity. The ball makes impact with the steel plate and rebounds so it passes again through the light screens. As the rebounding ball activates each light screen, the ball's time period at each screen is measured. This provides an outgoing transit time period which is inversely proportional to the ball's outgoing velocity. The CoR is then calculated as the ratio of the ball's outgoing transit time period to the ball's incoming transit time period (CoR=Vₒᵤₜ/Vᵢₙ=Tᵢₙ/Tₒᵤₜ).

Thermoset and thermoplastic layers herein may be treated in such a manner as to create a positive or negative hardness gradient within and between golf ball layers. In golf ball layers of the present invention wherein a thermosetting rubber is used, gradient-producing processes and/or gradient-producing rubber formulation may be employed. Gradient-producing processes and formulations are disclosed more fully, for example, in U.S. patent application Ser. No. 12/048,665, filed on Mar. 14, 2008; Ser. No. 11/829,461, filed on Jul. 27, 2007; Ser. No. 11/772,903, filed Jul. 3, 2007; Ser. No. 11/832,163, filed Aug. 1, 2007; Ser. No. 11/832,197, filed on Aug. 1, 2007; the entire disclosure of each of these references is hereby incorporated herein by reference.

It is understood that the golf balls made by a method of the invention wherein a thermoplastic cover is dimpled after a dimple-free golf ball is molded as described and illustrated herein, represent only some of the many embodiments of the invention. It is appreciated by those skilled in the art that various changes and additions can be made to such golf balls without departing from the spirit and scope of this invention. It is intended that all such embodiments be covered by the appended claims.

A golf ball of the invention may further incorporate indicia, which as used herein, is considered to mean any symbol, letter, group of letters, design, or the like, that can be added to the dimpled surface of a golf ball.

Golf balls of the present invention will typically have dimple coverage of 60% or greater, preferably 65% or greater, and more preferably 75% or greater. It will be appreciated that any known dimple pattern may be used with any number of dimples having any shape or size. For example, the number of dimples may be 252 to 456, or 330 to 392 and may comprise any width, depth, and edge angle. The parting line configuration of said pattern may be either a straight line or a staggered wave parting line (SWPL), for example.

In any of these embodiments the single-layer core may be replaced with a two or more layer core wherein at least one core layer has a hardness gradient.

Other than in the operating examples, or unless otherwise expressly specified, all of the numerical ranges, amounts, values and percentages such as those for amounts of materials and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

Although the golf ball of the invention has been described herein with reference to particular means and materials, it is to be understood that the invention is not limited to the particulars disclosed and extends to all equivalents within the scope of the claims.

It is understood that the manufacturing methods, compositions, constructions, and products described and illustrated herein represent only some embodiments of the invention. It is appreciated by those skilled in the art that various changes and additions can be made to compositions, constructions, and products without departing from the spirit and scope of this invention. It is intended that all such embodiments be covered by the appended claims.

1. A golf ball comprising a core; at least one intermediate layer surrounding the core that is comprised of at least one cross-linked polymer comprising a polyethylene-based vitrimer; wherein the polyethylene-based vitrimer comprises a polyethylene backbone, that is grafted with dioxaborolane maleimide, and a crosslinker containing dioxaborolane functional groups; and a cover that surrounds the intermediate layer.

2. (canceled)

3. The golf ball of claim 1, wherein the cross-linked polymer has a crosslink density of from about 0.2 to about 0.8.

4. The golf ball of claim 1, wherein the cross-linked polymer has a crosslink density of greater than 0.8.

5. (canceled)

6. The golf ball of claim 1, wherein the at least one polyethylene-based vitrimer is blended with at least one ionomer.

7. The golf ball of claim 6, wherein the at least one polyethylene-based vitrimer and the at least one ionomer are blended in a weight percent ratio of from about 2:98 to about 50:50.

8. The golf ball of claim 6, wherein the at least one polyethylene-based vitrimer at the at least one thermoplastic polyurethane are blended in a weight percent ratio of from about 2:98 to about 50:50.

9. The golf ball of claim 2, wherein the at least one polyethylene-based vitrimer is blended with at least one ionomer and at least one thermoplastic polyurethane.

10. The golf ball of claim 9, wherein the at least one polyethylene-based vitrimer, the at least one ionomer and the at least one thermoplastic polyurethane are blended in a weight percent ratio of from about 2:49:49 to about 50:25:25.

11. The golf ball of claim 9, wherein the polyethylene-based vitrimer is blended with the at least one ionomer and the at least one thermoplastic polyurethane in an amount of 2-50 parts per 100 parts of ionomer and polyurethane combined.

12. The golf ball of claim 11, wherein the at least one ionomer is included in an amount of at least 50 parts per 100 parts of ionomer and polyurethane combined.

13. The golf ball of claim 11, wherein the thermoplastic polyurethane is included in an amount of at least 50 parts per 100 parts of ionomer and polyurethane combined.

14. The golf ball of claim 9, wherein the ionomer and thermoplastic polyurethane are included in in a weight percent ratio of from about 80:20 to about 20:80.

16. The golf ball of claim 1, wherein the at least one layer comprises a thermoplastic blend of the polyethylene-based vitrimer and at least one ionomer; wherein the thermoplastic blend has a material hardness of from about 20 Shore D to about 70 Shore D.

17. The golf ball of claim 16, wherein the at least one layer consists of the thermoplastic blend.

18. (canceled)

19. The golf ball of claim 1, wherein the intermediate layer surrounds a single core.

20. The golf ball of claim 1, wherein the intermediate layer surrounds a subassembly comprised of an inner core and an outer core layer.

21. (canceled)

22. The golf ball of claim 1, wherein the polyethylene-based vitrimer has a melt flow index of from about 1 g/10 min@190° C./10 kg to about 5 g/10 min@ 190° C./10 kg.

23. The golf ball of claim 22, wherein the thermoplastic blend has a melt flow index of from about 1 g/10 min@190° C./2.16 kg to about 5 g/10 min@ 190° C./2.16 kg.

24. The golf ball of claim 1, wherein the polyethylene-based vitrimer has a freezing transition temperature Tv of at least about 140° C. and less than 200° C.

25. The golf ball of claim 1, wherein the polyethylene-based vitrimer has a freezing transition temperature Tv of at least about 100° C. and less than 190° C.

26. The golf ball of claim 1, wherein the polyethylene-based vitrimer has a freezing transition temperature Tv of from about 140° C. to about 185° C.

27. The golf ball of claim 1, wherein the polyethylene-based vitrimer has a relaxation time of from about 3 seconds to about 15 minutes.

28. (canceled)
